(19) United States
(12) Patent Application Publication
(10) Pub. No.: US 2026/0094079 A1
(43) Pub. Date: Apr. 2, 2026

(54) SUBSTRATE PROCESSING SYSTEM, SCHEDULE CREATING METHOD, STORAGE MEDIUM, AND SCHEDULE CREATING PROGRAM

(71) Applicant: SCREEN Holdings Co., Ltd., Kyoto (JP)

(72) Inventors: Shinji YAMAMOTO, Kyoto (JP); Hiroshi HORIGUCHI, Kyoto (JP)

(21) Appl. No.: 19/112,961

(22) PCT Filed: Sep. 14, 2023
(86) PCT No.: PCT/JP2023/033518

§ 371 Date: Mar. 18, 2025

(30) Foreign Application Priority Data
Sep. 22, 2022 (JP) 2022-151071

(51) Int. Cl. G06Q 10/0631

(52) U.S. Cl. CPC G06Q 10/06311

(57) ABSTRACT

A substrate processing includes a substrate processing apparatus and a controller. The controller is configured or programmed to create a schedule of operations of the substrate processing apparatus. The controller includes a storage portion and a controlling portion. The storage portion stores a plurality of trained models for creating a plurality of schedules that differ from each other in the usage amount of the utility. The controlling portion is capable of creating the plurality of schedules based on the plurality of trained models. The plurality of trained models are each constructed by executing reinforcement learning based on learning input data. The learning input data includes substrate count information, recipe information, and utility information. The utility information includes the usage amount of the utility used in each action included in a procedure of the operations of the substrate processing apparatus.

### TECHNICAL FIELD

The present invention relates to a substrate processing system, a schedule creating method, a storage medium, and a schedule creating program.

### BACKGROUND ART

There is known a schedule creating apparatus that positions, along a time sequence, a plurality of blocks specifying contents of operations of a substrate processing apparatus and creates a schedule specifying the operations of the substrate processing apparatus along the time sequence (see, for example, Patent Literature 1). The schedule creating apparatus of Patent Literature 1 outputs the schedule of maximum throughput.

### CITATION LIST

### Patent Literature

Patent Literature 1: Japanese Patent Application Publication No. 2021-36582

### SUMMARY OF INVENTION

### Technical Problem

However, there are cases where it is desired to prioritize suppression of a usage amount of a utility over throughput. A case where it is desired to prioritize suppression of the usage amount of the utility over throughput is, for example, a case where supply of electric power or water is limited during predetermined hours in a region in which a substrate processing apparatus is installed and a case where a raw material of a processing fluid (for example, a raw material of a chemical liquid or an inert gas) is in shortage. Although it is possible to adjust various setting values (values of various parameters) of the substrate processing apparatus to suppress the usage amount of the utility, this requires much time and effort. Also, there is a possibility of degradation of quality of substrate processing when setting values are changed.

The present invention has been made in view of the above problem and an object thereof is to provide a substrate processing system, a schedule creating method, a storage medium, and a schedule creating program that are capable of suppressing a usage amount of a utility.

### Solution to Problem

According to one aspect of the present system, a substrate processing system includes a substrate processing apparatus and a controller. The substrate processing apparatus uses a utility to process a substrate. The controller positions, along a time sequence, a plurality of blocks specifying contents of operations of the substrate processing apparatus based on substrate count information, recipe information, and utility information and creates a schedule specifying the operations of the substrate processing apparatus along the time sequence. The substrate count information indicates the number of the substrates to be processed by the substrate processing apparatus. The recipe information specifies a procedure of operations of the substrate processing apparatus. The utility information indicates a usage amount of the utility used in each action included in the procedure of the operations of the substrate processing apparatus. The controller includes a storage portion and a controlling portion. The storage portion stores a plurality of trained models for creating a plurality of schedules differing from each other in the usage amount of the utility. The controlling portion is capable of creating the plurality of schedules based on schedule creation input data and the plurality of trained models. The schedule creation input data includes the substrate count information, the recipe information, and the utility information. The plurality of trained models are each constructed by executing reinforcement learning based on learning input data. The learning input data includes the substrate count information, the recipe information, and the utility information.

In a preferred embodiment, the plurality of schedules include a first schedule and a second schedule. In comparison to the first schedule, the second schedule is later in end time.

In a preferred embodiment, the plurality of schedules include a first schedule and a second schedule. In comparison to the first schedule, the second schedule is smaller in peak value of the usage amount of the utility.

In a preferred embodiment, the plurality of schedules include a first schedule and a second schedule. In comparison to the first schedule, the second schedule is less in total amount of the usage amount of the utility.

In a preferred embodiment, the utility includes at least one of a processing liquid, electric power, and a gas.

In a preferred embodiment, the substrate processing apparatus includes a substrate processing portion to process the substrate. The schedule creation input data and the learning input data further include information indicating a position of the substrate processing portion.

In a preferred embodiment, the plurality of schedules include a first schedule and a second schedule. In comparison to the first schedule, the second schedule disperses timings of start of processing of a plurality of the substrates by the substrate processing apparatus.

In a preferred embodiment, the plurality of schedules include a first schedule and a second schedule. The substrate processing apparatus includes a substrate processing portion and a chemical liquid cabinet. The substrate processing portion uses a first chemical liquid to process a first substrate. The substrate processing portion uses a second chemical liquid to process a second substrate. The chemical liquid cabinet stores, exclusively of each other, the first chemical liquid and the second chemical liquid supplied to the substrate processing portion. In comparison to the first schedule, the second schedule is less in the number of times the first chemical liquid and the second chemical liquid are switched in the chemical liquid cabinet.

In a preferred embodiment, the substrate processing apparatus further includes a first substrate processing portion, a second substrate processing portion, a first chemical liquid cabinet, and a second chemical liquid cabinet. The first substrate processing portion uses a first chemical liquid or a second chemical liquid to process the substrate. The second substrate processing portion uses the first chemical liquid or the second chemical liquid to process the substrate. The first chemical liquid cabinet is capable of storing exclusively the first chemical liquid or the second chemical liquid supplied to the first substrate processing portion. The second chemical liquid cabinet is capable of storing exclusively the first chemical liquid or the second chemical liquid supplied to the second substrate processing portion. The plurality of schedules include a schedule that makes the first chemical liquid be supplied from the first chemical liquid cabinet to the first substrate processing portion and the second chemical liquid be supplied from the second chemical liquid cabinet to the second substrate processing portion.

In a preferred embodiment, the second chemical liquid differs in type from the first chemical liquid.

In a preferred embodiment, the second chemical liquid differs in temperature or concentration from the first chemical liquid.

In a preferred embodiment, the plurality of schedules include a first schedule and a second schedule. The substrate processing apparatus includes a plurality of substrate processing portions to process the substrate. In comparison to the first schedule, the second schedule makes a fewer number of the substrate processing portions process the substrate.

In a preferred embodiment, the plurality of schedules include a first schedule and a second schedule. The substrate processing apparatus includes a substrate processing portion to process the substrate. In comparison to the first schedule, the second schedule is shorter in a period in which the substrate processing portion does not process the substrate.

In a preferred embodiment, the substrate processing apparatus includes a substrate processing portion to process the substrate. When a fixed time elapses, the substrate processing portion executes a specific process in a period in which the substrate is not processed. The plurality of schedules include a schedule that makes the substrate processing portion, for which the fixed time has elapsed, execute processing of the substrate in continuation.

In a preferred embodiment, the substrate processing apparatus includes a substrate processing portion and a chemical liquid cabinet. The substrate processing portion uses a chemical liquid to process the substrate. The chemical liquid cabinet stores the chemical liquid supplied to the substrate processing portion. When a fixed time elapses, the substrate processing apparatus executes an exchange process of the chemical liquid stored in the chemical liquid cabinet. The plurality of schedules include a schedule that makes the substrate processing portion execute processing of the substrate in continuation after elapse of the fixed time.

In a preferred embodiment, the plurality of schedules include a first schedule and a second schedule. The substrate processing apparatus includes a transfer portion that transfers the substrate. In comparison to the first schedule, the second schedule is less in the number of times of operation of the transfer portion.

In a preferred embodiment, the substrate processing apparatus includes a plurality of towers. The plurality of towers each include a plurality of substrate processing portions to process the substrate. The plurality of schedules include a schedule that makes the substrate be processed by the substrate processing portion included in a specific tower among the plurality of towers.

In a preferred embodiment, the substrate processing apparatus includes a plurality of chemical liquid cabinets to store a chemical liquid. The plurality of schedules include a schedule that makes the substrate be processed by the chemical liquid stored in a specific chemical liquid cabinet among the plurality of chemical liquid cabinets.

In a preferred embodiment, the controlling portion creates the plurality of schedules based on the plurality of trained models. The controlling portion acquires an end time of each of the plurality of schedules. The controlling portion selects from among the plurality of schedules a schedule with which the end time is a time within an allowable range and a total amount of the usage amount of the utility is minimized.

According to another aspect of the present invention, a schedule creating method positions, along a time sequence, a plurality of blocks specifying contents of operations of a substrate processing apparatus using a utility to process a substrate and creates a schedule specifying the operations of the substrate processing apparatus along the time sequence. The schedule creating method includes a schedule creating step of creating at least one of a plurality of schedules differing from each other in usage amount of the utility based on schedule creation input data and at least one of a plurality of trained models. The schedule creation input data includes substrate count information, recipe information, and utility information. The substrate count information indicates the number of the substrates to be processed by the substrate processing apparatus. The recipe information specifies a procedure of operations of the substrate processing apparatus. The utility information indicates the usage amount of the utility used in each action included in the procedure of the operations of the substrate processing apparatus. The plurality of trained models are each constructed by executing reinforcement learning based on learning input data. The learning input data includes the substrate count information, the recipe information, and the utility information.

In a preferred embodiment, the plurality of schedules include a first schedule and a second schedule. In comparison to the first schedule, the second schedule is later in end time.

In a preferred embodiment, the plurality of schedules include a first schedule and a second schedule. In comparison to the first schedule, the second schedule is smaller in peak value of the usage amount of the utility.

In a preferred embodiment, the plurality of schedules include a first schedule and a second schedule. In comparison to the first schedule, the second schedule is less in total amount of the usage amount of the utility.

In a preferred embodiment, the utility includes at least one of a processing liquid, electric power, and a gas.

In a preferred embodiment, the substrate processing apparatus includes a substrate processing portion to process the substrate. The schedule creation input data and the learning input data further include information indicating a position of the substrate processing portion.

In a preferred embodiment, the plurality of schedules include a first schedule and a second schedule. In comparison to the first schedule, the second schedule disperses timings of start of processing of a plurality of the substrates by the substrate processing apparatus.

In a preferred embodiment, the plurality of schedules include a first schedule and a second schedule. The substrate processing apparatus includes a substrate processing portion and a chemical liquid cabinet. The substrate processing portion uses a first chemical liquid to process a first substrate. The substrate processing portion uses a second chemical liquid to process a second substrate. The chemical liquid cabinet stores, exclusively of each other, the first chemical liquid and the second chemical liquid supplied to the substrate processing portion. In comparison to the first schedule, the second schedule is less in the number of times the first chemical liquid and the second chemical liquid are switched in the chemical liquid cabinet.

In a preferred embodiment, the substrate processing apparatus further includes a first substrate processing portion, a second substrate processing portion, a first chemical liquid cabinet, and a second chemical liquid cabinet. The first substrate processing portion uses a first chemical liquid or a second chemical liquid to process the substrate. The second substrate processing portion uses the first chemical liquid or the second chemical liquid to process the substrate. The first chemical liquid cabinet is capable of storing exclusively the first chemical liquid or the second chemical liquid supplied to the first substrate processing portion. The second chemical liquid cabinet is capable of storing exclusively the first chemical liquid or the second chemical liquid supplied to the second substrate processing portion. The plurality of schedules include a schedule that makes the first chemical liquid be supplied from the first chemical liquid cabinet to the first substrate processing portion and the second chemical liquid be supplied from the second chemical liquid cabinet to the second substrate processing portion.

In a preferred embodiment, the second chemical liquid differs in type from the first chemical liquid.

In a preferred embodiment, the second chemical liquid differs in temperature or concentration the first chemical liquid.

In a preferred embodiment, the plurality of schedules include a first schedule and a second schedule. The substrate processing apparatus includes a plurality of substrate processing portions to process the substrate. In comparison to the first schedule, the second schedule makes a fewer number of the substrate processing portions process the substrate.

In a preferred embodiment, the plurality of schedules include a first schedule and a second schedule. The substrate processing apparatus includes a substrate processing portion to process the substrate. In comparison to the first schedule, the second schedule is shorter in a period in which the substrate processing portion does not process the substrate.

In a preferred embodiment, the substrate processing apparatus includes a substrate processing portion to process the substrate. When a fixed time elapses, the substrate processing portion executes a specific process in a period in which the substrate is not processed. The plurality of schedules include a schedule that makes the substrate processing portion, for which the fixed time has elapsed, execute processing of the substrate in continuation.

In a preferred embodiment, the substrate processing apparatus includes a substrate processing portion and a chemical liquid cabinet. The substrate processing portion uses a chemical liquid to process the substrate. The chemical liquid cabinet stores the chemical liquid supplied to the substrate processing portion. When a fixed time elapses, the substrate processing apparatus executes an exchange process of the chemical liquid stored in the chemical liquid cabinet. The plurality of schedules include a schedule that makes the substrate processing portion execute processing of the substrate in continuation after elapse of the fixed time.

In a preferred embodiment, the plurality of schedules include a first schedule and a second schedule. The substrate processing apparatus includes a transfer portion that transfers the substrate. In comparison to the first schedule, the second schedule is less in the number of times of operation of the transfer portion.

In a preferred embodiment, the substrate processing apparatus includes a plurality of towers. The plurality of towers each include a plurality of substrate processing portions to process the substrate. The plurality of schedules include a schedule that makes the substrate be processed by the substrate processing portion included in a specific tower among the plurality of towers.

In a preferred embodiment, the substrate processing apparatus includes a plurality of chemical liquid cabinets to store a chemical liquid. The plurality of schedules include a schedule that makes the substrate be processed by the chemical liquid stored in a specific chemical liquid cabinet among the plurality of chemical liquid cabinets.

In a preferred embodiment, the schedule creating step includes a step of creating the plurality of schedules based on the plurality of trained models, a step of acquiring an end time of each of the plurality of schedules, and a step of selecting from among the plurality of schedules a schedule with which the end time is a time within an allowable range and a total amount of the usage amount of the utility is minimized.

According to yet another aspect of the present invention, a storage medium is a non-transitory computer readable storage medium storing a schedule creating program to be executed by a computer. The schedule creating program makes the computer execute computing in accordance with the schedule creating method described above.

According to yet another aspect of the present invention, a schedule creating program is executed by a computer. The schedule creating program makes the computer execute computing in accordance with the schedule creating method described above.

### Advantageous Effect(s) of Invention

By the substrate processing system, the schedule creating method, the storage medium, and the schedule creating program according to the present invention, a usage amount of a utility can be suppressed.

### BRIEF DESCRIPTION OF DRAWINGS

FIG. 1 is a block diagram showing the arrangement of a learning device.

FIG. 2 is a plan view schematically showing an example of the arrangement of a substrate processing apparatus included in a substrate processing system according to preferred embodiment 1 of the present invention.

FIG. 3 is a side view schematically showing the example of the arrangement of the substrate processing apparatus included in the substrate processing system according to preferred embodiment 1 of the present invention.

FIG. 4 is a diagram showing an example of utility information.

FIG. 5 is a sequence diagram showing a flow of processes of reinforcement learning.

FIG. 6 is a diagram showing a first example of a first schedule.

FIG. 7 is a diagram showing an example of a second schedule.

FIGS. 8(a) and (b) are diagrams showing other examples of the second schedule.

FIG. 9 is a diagram showing a second example of the first schedule.

FIGS. 10(a) and (b) are diagrams showing a first example of a third schedule.

FIG. 11(a) is a diagram showing a third example of the first schedule. (b) is a diagram showing a second example of the third schedule.

FIG. 12(a) is a diagram showing a fourth example of the first schedule. (b) is a diagram showing a first example of a fourth schedule.

FIG. 13(a) is a diagram showing a fifth example of the first schedule. (b) is a diagram showing a second example of the fourth schedule.

FIG. 14 is a block diagram showing the arrangement of a controller included in the substrate processing system according to preferred embodiment 1 of the present invention.

FIG. 15 is a diagram showing mode information indicating a relationship between operation modes of the substrate processing apparatus included in the substrate processing system according to preferred embodiment 1 of the present invention and schedule creating programs.

FIG. 16 is a diagram showing a mode selection screen.

FIG. 17 is a sequence diagram showing a flow of processes in creating a schedule.

FIG. 18 is a diagram showing a confirmation screen displayed on a display portion included in the substrate processing system according to preferred embodiment 2 of the present invention.

FIG. 19 is a flowchart showing a flow of processes executed by the controlling portion included in the substrate processing system according to preferred embodiment 2 of the present invention.

FIG. 20 is a diagram showing a confirmation screen displayed on the display portion included in the substrate processing system according to preferred embodiment 3 of the present invention.

FIG. 21 flowchart showing of processes executed by the controlling portion included in the substrate processing system according to preferred embodiment 3 of the present invention.

FIG. 22 is a diagram showing a mode selection screen displayed on the display portion included in the substrate processing system according to preferred embodiment 4 of the present invention.

FIG. 23 is a flowchart showing a flow of processes executed by the controlling portion included in the substrate processing System according to preferred embodiment 5 of the present invention.

### DESCRIPTION OF PREFERRED EMBODIMENTS

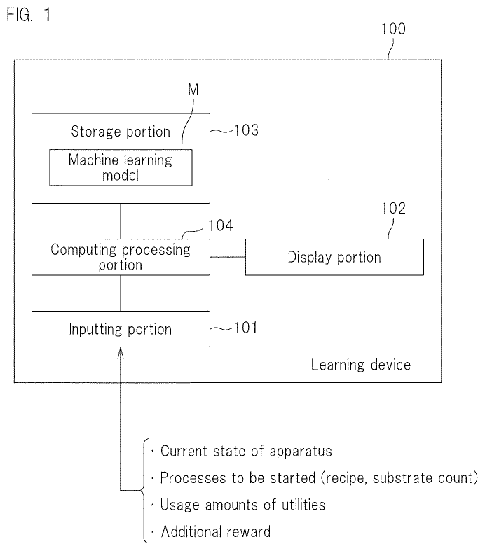

Preferred embodiments related to a substrate processing system, a schedule creating method, a storage medium, and a schedule creating program of the present invention shall now be described with reference to the drawings (FIG. 1 to FIG. 23). However, the present invention is not restricted to the preferred embodiments described below and can be implemented in various modes within a scope not deviating from its gist. It is noted that, for portions for which description is redundant, the description is at times omitted as appropriate. Also, in the figures, same or corresponding portions are provided with the same reference sign and description shall not be repeated.

As a “substrate” in the preferred embodiments of the present invention, any of various substrates such as semiconductor wafers, glass substrates for photomasks, glass substrates for liquid crystal displays, glass substrates for plasma displays, substrates for FEDs (field emission displays), substrates for optical disks, substrate for magnetic disks, substrates for magneto-optical disks, etc., is applicable. Although the preferred embodiments of the present invention shall mainly be described below with a substrate processing system, a schedule creating method, a storage medium, and a schedule creating program used in processing of a semiconductor wafer of disk shape as examples, application to processing of any of the various substrates given above as examples is likewise possible as well. Also, in regard to the shape of the substrate, various types are applicable.

### Preferred Embodiment 1

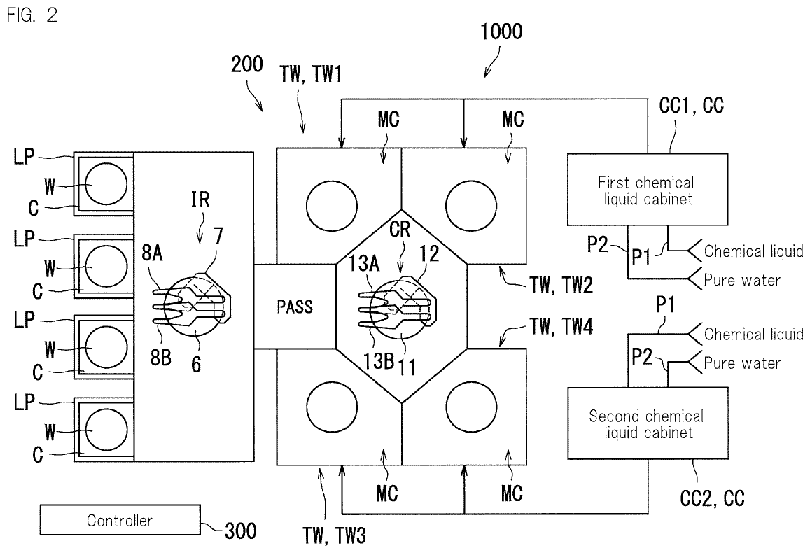

First, a learning device 100 shall be described with reference to FIG. 1 and FIG. 2. FIG. 1 is a block diagram showing the arrangement of the learning device 100. FIG. 2 is a plan view schematically showing an example of the arrangement of a substrate processing apparatus 200 included in a substrate processing system 1000 of the present preferred embodiment.

As shown in FIG. 2, the substrate processing system 1000 includes the substrate processing apparatus 200 and a controller 300. The learning device 100 shown in FIG. 1 creates a schedule creating program by reinforcement learning. The schedule creating program is a program for creating a schedule SK that specifies operations of the substrate processing apparatus 200 along a time sequence. A trained model constructed by the reinforcement learning is included in the schedule creating program.

Specifically, the learning device 100 includes a machine learning model M. The learning device 100 uses the machine learning model M to create the schedule SK. The machine learning model M is a reinforcement learning model. The machine learning model M may, for example, be a deep reinforcement learning model. The learning device 100 creates the schedule SK repeatedly and constructs the trained model.

An environment of the reinforcement learning is the substrate processing apparatus 200 and the learning device 100 stores information indicating the arrangement of the substrate processing apparatus 200. Agents of the reinforcement learning are the respective constituent elements of the substrate processing apparatus 200 and actions of the reinforcement learning are actions of the respective constituent elements of the substrate processing apparatus 200.

In detail, the learning device 100 stores general configuration information that indicates a general configuration of the substrate processing apparatus 200. Specifically, as shown in FIG. 2, the substrate processing apparatus 200 includes a plurality of load ports LP, an indexer robot IR, a passing portion PASS, a center robot CR, a plurality of substrate processing portions MC, and at least one chemical liquid cabinet CC. In the present preferred embodiment, the at least one chemical liquid cabinet CC includes a first chemical liquid cabinet CC1 and a second chemical liquid cabinet CC2. The general configuration information indicates one of the plurality of load ports LP, the indexer robot IR, the passing portion PASS, the center robot CR, and the plurality of substrate processing portions MC. The agents of the reinforcement learning include the indexer robot IR, the center robot CR, and the plurality of substrate processing portions MC and the actions of the reinforcement learning include an action of the indexer robot IR, an action of the center robot CR, and actions of the plurality of substrate processing portions MC. It is noted that information indicating positions of the substrate processing portions MC is not included in the general configuration information. Also, information indicating a connection relationship between the substrate processing portions MC and the chemical liquid cabinets CC is not included in the general configuration information.

The controller 300 shown in FIG. 2 stores the schedule creating program created by the learning device 100 shown in FIG. 1. The controller 300 creates the schedule SK based on the schedule creating program when a substrate housing container C docks into any one of the plurality of load ports LP. The schedule SK specifies, along a time sequence, the operations of the substrate processing apparatus 200 when substrate processing is executed on a plurality of substrates W housed in the substrate housing container C docked in the load port LP. Specifically, the schedule SK specifies the action of the indexer robot IR, the action of the center robot CR, and the actions of the plurality of substrate processing portions MC along the time sequence.

It is noted that, in the following description, performing of substrate processing on the plurality of substrates W housed in the substrate housing container C docked in the load port LP is referred to at times as the “current project PJ.”

The learning device 100 shall be described further with reference to FIG. 1. As shown in FIG. 1, the learning device 100 includes an inputting portion 101, a display portion 102, a storage portion 103, and a computing processing portion 104.

The inputting portion 101 is a user interface device manipulated by a worker. The inputting portion 101 inputs into the computing processing portion 104 an instruction (control signal) that is in accordance with the manipulation by the worker. Also, the inputting portion 101 inputs into the computing processing portion 104 data that is in accordance with the manipulation by the worker. The inputting portion 101 may include a keyboard and a mouse. The inputting portion 101 may include a touch sensor superposed on a display surface of the display portion 102. A graphical user interface may be arranged by the touch sensor being superposed on the display surface of the display portion 102.

For example, the worker can manipulate the inputting portion 101 and input a current apparatus state, contents of processes to be started (contents of the current project PJ), utility information RS, and an additional reward into the computing processing portion 104.

The current apparatus state indicates current states of the respective constituent elements of the substrate processing apparatus 200. For example, the current apparatus state indicates a current state of the indexer robot IR, a current state of the center robot CR, and current states of the plurality of substrate processing portions MC. The worker assumes and inputs an arbitrary state as the current apparatus state. When a state in which a substrate W remains in an interior of the substrate processing apparatus 200 is assumed, a position of the substrate W remaining inside the substrate processing apparatus 200 is further included in the current apparatus state. For example, when the indexer robot IR is gripping the substrate W, information indicating that the substrate W is gripped by the indexer robot IR is included in the current apparatus state.

The contents of the processes to be started (contents of the current project PJ) include substrate count information and recipe information. The substrate count information indicates the number of substrates W to be processed by the substrate processing apparatus 200. Specifically, the substrate count information indicates the number of substrates W housed in the substrate housing container C docked in the load port LP. The worker assumes and inputs an arbitrary number of substrates as the substrate count information.

The recipe information specifies a procedure of the operations of the substrate processing apparatus 200 with respect to the substrates W. In detail, the recipe information specifies the procedure of the operations of the substrate processing apparatus 200 in the current project PJ. The worker assumes and inputs arbitrary contents as the contents of the processes to be started.

More specifically, the recipe information includes a process recipe, a pre-recipe, a post-recipe, and a flow recipe. The process recipe includes a substrate processing recipe R and a chemical liquid recipe KC.

The substrate processing recipe R specifies contents of processes with respect to the substrates W. Specifically, the substrate processing recipe R includes a procedure of processes with respect to the substrates W and conditions of the processes. The chemical liquid recipe KC specifies contents of operations of the chemical liquid cabinets CC. Specifically, the chemical liquid recipe KC includes a procedure of processes executed by the chemical liquid cabinets CC and conditions of chemical liquids to be stored in the chemical liquid cabinets CC.

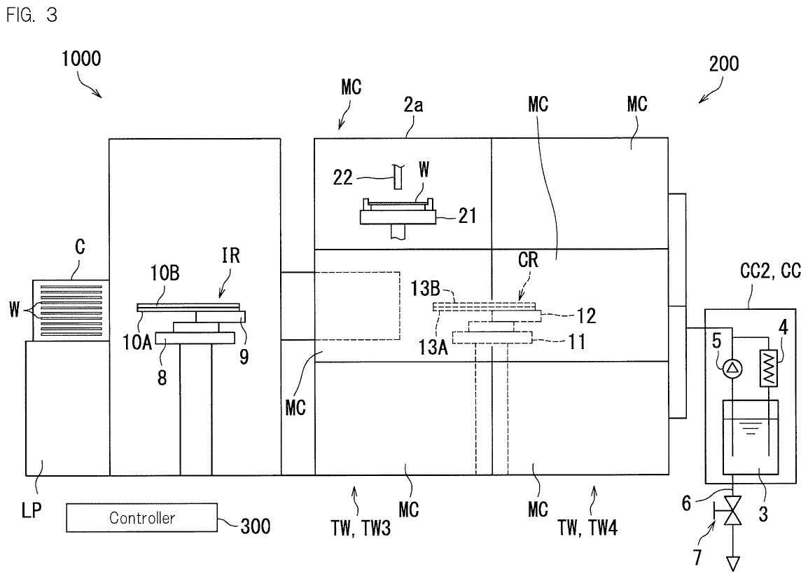

The pre-recipe specifies contents of a preprocess by the substrate processing portions MC. The preprocess is executed at a start time of the current project PJ. For example, the preprocess includes a predispense process. The predispense process indicates a process of making a nozzle 22 (see FIG. 3) discharge, from the nozzle 22, a chemical liquid present in an interior of a piping that supplies the chemical liquid.

The post-recipe specifies contents of a postprocess. The postprocess is executed at an end time of the current project PJ. For example, the postprocess includes a process of cleaning an interior of a chamber 2a (see FIG. 3). The process of cleaning the interior of the chamber 2a may include a process of cleaning chuck pins holding a substrate W and a process of cleaning another component (for example, a processing cup) inside the chamber 2a.

The flow recipe specifies an execution sequence and the number of times of execution of control that is in accordance with the process recipe (process recipe control), control that is in accordance with the pre-recipe (pre-recipe control), and control that is in accordance with the post-recipe (post-recipe control).

The utility information RS indicates a usage amount of a utility. For example, the utility information RS indicates at least one of a usage amount of a processing liquid, a usage amount of electric power, and a usage amount of a gas. As the utility information RS, the worker may input information indicating the usage amounts of the utilities used in respective actions executable by the substrate processing apparatus 200. Or, as the utility information RS, the worker may input the usage amounts of the utilities used in the current project PJ. Specifically, the worker may input the usage amounts of the utilities used in respective actions included in the procedure of the operations of the substrate processing apparatus 200 based on the current project PJ.

The additional reward is added to a reward that the learning device 100 provides to the schedule SK. In detail, the worker creates a plurality of schedule creating programs using the learning device 100. The plurality of schedule creating programs respectively create schedules SK. The worker adds rewards such that a plurality of schedules SK differing from each other in the usage amounts of the utilities are created by the plurality of schedule creating programs. Hereinafter, a reward that the learning device 100 provides to a schedule SK is referred to at times as the “initial reward.” Also, a reward with which the additional reward is added to the initial reward is referred to at times as the “final reward.”

It is noted that, the inputting portion 101 may further include an interface accessible to a removable medium. The removable medium may include, for example, a memory card such as an SD card. The removable medium may include, for example, a USB memory. The removable medium may include, for example, an optical disk such as a CD (compact disk) or a DVD. The interface may include, for example, a slot into which the memory card is inserted. The interface may include, for example, a USB terminal. The interface may include, for example, reading device that reads data from the optical disk. A USB cable of a memory card reader may be connected to the USB terminal.

The display portion 102 displays various screens or images. For example, the display portion 102 displays a screen for manipulation of the learning device 100 by the worker. Also, the display portion 102 displays the schedule SK output from the machine learning model M. The worker checks the schedule SK displayed on the display portion 102 and inputs the additional reward. The display portion 102 includes, for example, a display device such as a liquid crystal display device or an organic EL (electroluminescence) display device.

The storage portion 103 has a main storage device. The main storage device includes, for example, a semiconductor memory. The storage portion 103 further has an auxiliary storage device. The auxiliary storage device includes, for example, at least one of a semiconductor memory and a hard disk drive. The storage portion 103 may include a removable medium.

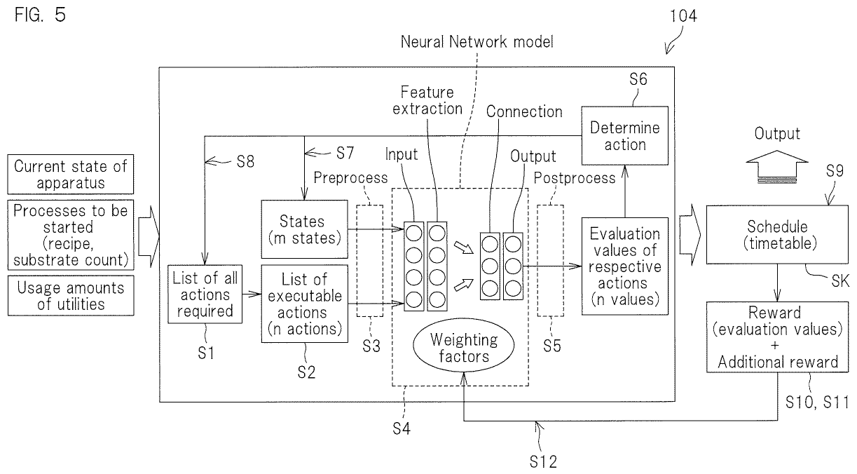

The storage portion 103 stores various computer programs and various data. The various data include the general configuration information described with reference to FIG. 1 and FIG. 2. The various computer programs include a program for machine learning. The program for machine learning includes the machine learning model M. More specifically, the program for machine learning includes a program for the reinforcement learning. An algorithm for the reinforcement learning is not restricted in particular and may, for example, be an algorithm conforming to Q learning, SARSA method, policy gradient method, Actor-Critic method, or Monte Carlo method. The algorithm for the reinforcement learning constructs a prediction model as the trained model. The prediction model predicts “evaluation values of the respective next executable actions (Q values)” that are described with reference to FIG. 5.

The prediction model includes, for example, a neural network. The neural network includes an input layer, a single or plurality of intermediate layers, and an output layer. Specifically, the neural network includes a deep neural network (DNN), a recurrent neural network (RNN), a convolutional neural network (CNN), or a quantum neural network (QNN) and performs deep learning. For example, the deep neural network includes an input layer, a plurality of intermediate layers (hidden layers), and an output layer.

The computing processing portion 104 includes a processor. The computing processing portion 104 includes, for example, a CPU (central processing unit) or an MPU (micro processing unit) as the processor. Or the computing processing portion 104 may include a general-purpose computer, a specialized computing unit, a GPU (graphics processing unit), an NPU (neural network processing unit), or a quantum computer. The specialized computing unit includes, for example, an ASIC (application specific integrated circuit).

The computing processing portion 104 executes various processes based on the various programs and various data stored in the storage portion 103. For example, the computing processing portion 104 creates the schedule SK based on the program for the reinforcement learning. Specifically, the computing processing portion 104 uses the machine learning model M to create the schedule SK and acquires a reward (the initial reward) for the created schedule SK. The computing processing portion 104 repeats the creation of the schedule SK and constructs the trained model (prediction model). As a result, the schedule creating program including the trained model (prediction model) is generated.

Here, the arrangement of the substrate processing apparatus 200 shall be described with reference to FIG. 2 and FIG. 3. FIG. 3 is a side view schematically showing the example of the arrangement of the substrate processing apparatus 200 included in the substrate processing system 1000 of the present preferred embodiment. As already described, the substrate processing apparatus 200 includes the plurality of load ports LP, the indexer robot IR, the passing portion PASS, the center robot CR, the plurality of substrate processing portions MC, the first chemical liquid cabinet CC1, and the second chemical liquid cabinet CC2.

The substrate housing containers C are docked in the load ports LP. In detail, the substrate housing containers C that house substrates W before processing are docked in a portion of the plurality of load ports LP. Substrate housing containers C that are empty are docked in the remaining load ports LP. The substrates W after processing are housed in the substrate housing containers C that are empty. Each substrate housing container C houses a plurality of the substrates W in a stacked state. Specifically, the plurality of substrates W are stacked inside the substrate housing container C in a vertical direction in a horizontal orientation at intervals from each other. Here, the horizontal orientation refers to a state in which a thickness direction of each substrate W is oriented along the vertical direction. The substrate housing container C may, for example, be a FOUP (front opening unified pod) or may be a SMIF (standard mechanical interface) pod or may be an OC (open cassette).

The indexer robot IR transfers a substrate W before processing from the substrate housing container C to the passing portion PASS and transfers the substrate W after processing from the passing portion PASS to the substrate housing container C. The indexer robot IR is an example of a “transfer portion.” Specifically, the indexer robot IR includes a base portion 8, an articulated arm 9, and two hands 10A and 10B.

The base portion 8 supports a base end portion of the articulated arm 9. In more detail, the base portion 8 supports the base end portion of the articulated arm 9 rotatably and vertically movably. Specifically, the base portion 8 has an arm rotating mechanism and an arm elevating/lowering mechanism. The arm rotating mechanism rotates the articulated arm 9 around a vertical axis. In detail, the arm rotating mechanism rotates the articulated arm 9 in both normal and reverse directions. The arm elevating/lowering mechanism elevates and lowers the articulated arm 9. The articulated arm 9 is thus rotatable with respect to the base portion 8. Also, the articulated arm 9 is vertically movable with respect to the base portion 8.

The articulated arm 9 is bendable/extendable in horizontal directions. Specifically, the articulated arm 9 has a plurality of arm portions, a plurality of joint portions, and a plurality of individual rotating mechanisms. Two arm portions are connected to each joint portion. The arm portions are each rotatable with respect to the connected: portion. The individual rotating mechanisms are provided at the joint portions and rotate the corresponding arm portions along a horizontal plane. In detail, the individual rotating mechanisms rotate the corresponding arm portions in both normal and reverse directions.

The hands 10A and 10B are supported at a tip portion of the articulated arm 9. The articulated arm 9 further has a hand rotating mechanism that rotates the hands 10A and 10B individually around vertical axes and a hand advancing/retreating mechanism that makes the hands 10A and 10B advance/retreat individually in the horizontal directions. The hands 10A and 10B are thus individually rotatable with respect to the articulated arm 9. In detail, the hands 10A and 10B are each rotatable in both normal and reverse directions. Also, the hands 10A and 10B are advanceable/retreatable individually with respect to the articulated arm 9.

The hands 10A and 10B each hold a single substrate W. It is noted that, although the hands 10A and 10B may be positioned such as to overlap vertically, in FIG. 2, the hands 10A and 10B are shown as being shifted in a direction parallel to the sheet surface (a horizontal direction) for clarity.

Next, the passing portion PASS shall be described. The passing portion PASS has a plurality of shelves (not shown) that support the substrates W. In detail, the passing portion PASS has at least one shelf (not shown) that supports a substrate W before processing and at least one shelf (not shown) that supports the substrate W after processing. In the present preferred embodiment, the passing portion PASS has two shelves (not shown) that support substrates W before processing and two shelves (not shown) that support the substrates W after processing.

Next, the center robot CR shall be described. The center robot CR transfers the substrates W before processing from the passing portion PASS to the substrate processing portions MC and transfers the substrates W after processing from the substrate processing portions MC to the passing portion PASS. The center robot CR is an example of the “transfer portion.” Specifically, the center robot CR has a base portion 11, an articulated arm 12, and two hands 13A and 13B.

The base portion 11 supports a base end portion of the articulated arm 12. In more detail, the base portion 11 supports the base end portion of the articulated arm 12 rotatably and vertically movably. Specifically, the base portion 11 has an arm rotating mechanism and an arm /evating/ lowering mechanism. The arm rotating mechanism rotates the articulated arm 12 around a vertical axis. In detail, the arm rotating mechanism rotates the articulated arm 12 in both normal and reverse directions. The arm elevating/lowering mechanism elevates and lowers the articulated arm 12. The articulated arm 12 is thus rotatable with respect to the base portion 11. Also, the articulated arm 12 is vertically movable with respect to the base portion 11.

The articulated arm 12 is bendable/extendable in horizontal directions. Specifically, the articulated arm 12 has a plurality of arm portions, a plurality of joint portions, and a plurality of individual rotating mechanisms. Two arm portions are connected to each joint portion. The arm portions are each rotatable with respect to the connected portion. The individual rotating mechanisms are provided at the joint portions and rotate the corresponding arm portions along a horizontal plane. In detail, the individual rotating mechanisms rotate the corresponding arm portions in both normal and reverse directions.

The hands 13A and 13B are supported at a tip portion of the articulated arm 12. The articulated arm 12 further has a hand rotating mechanism that rotates the hands 13A and 13B individually around vertical axes and a hand advancing/retreating mechanism that makes the hands 13A and 13B advance/retreat individually in the horizontal directions. The hands 13A and 13B are thus individually rotatable with respect to the articulated arm 12. In detail, the hands 13A and 13B are each rotatable in both normal and reverse directions. Also, the hands 13A and 13B are advanceable/retreatable individually with respect to the articulated arm 12.

The hands 13A and 13B each hold a single substrate W. It is noted that, although the hands 13A and 13B may be positioned such as to overlap vertically, in FIG. 2, the hands 13A and 13B are shown as being shifted in a direction parallel to the sheet surface (a horizontal direction) for clarity.

Next, the substrate processing portions MC shall be described. The substrate processing apparatus 200 shown in FIG. 2 and FIG. 3 is a single substrate processing type apparatus and each substrate processing portion MC processes one substrate W at a time. In the present preferred embodiment, the substrate processing portion MC supplies a processing liquid to the substrate W to process the substrate W. The processing liquid is not restricted in particular as long as it is a liquid that contacts the substrate W. In the present preferred embodiment, the processing liquid includes a chemical liquid and a rinse liquid.

The chemical liquid is, for example, dilute hydrofluoric acid (DHF), hydrofluoric acid (HF), nitric hydrofluoric acid (mixed liquid of hydrofluoric acid and nitric acid (HNO₃), buffered hydrofluoric acid (BHF), ammonium fluoride, HFEG (mixed liquid of hydrofluoric acid and ethylene glycol), phosphoric acid (H₃PO₄), sulfuric acid, acetic acid, nitric acid, hydrochloric acid, ammonia water, hydrogen peroxide water, an organic acid (for example, citric acid, oxalic acid), an organic alkali (for example, TMAH: tetramethylammonium hydroxide), sulfuric acid/hydrogen peroxide water mixture (SPM), ammonia/hydrogen peroxide water mixture (SC1), hydrochloric acid/hydrogen peroxide water mixture (SC2), isopropyl alcohol (IPA), a surfactant, or a corrosion inhibitor.

The rinse liquid is, for example, pure water (for example, deionized water), carbonated water, electrolyzed ion water, hydrogen water, one water, or an aqueous hydrochloric acid solution of dilute concentration (for example, approximately 10 ppm to 100 ppm).

As shown in FIG. 3, the substrate processing portion MC may include, for example, the chamber 2a, a spin chuck 21, and the nozzle 22. The chamber 2a has a substantially box shape and houses the spin chuck 21 and the nozzle 22. Also, the chamber 2a houses the substrate W transferred into the chamber 2a. The spin chuck 21 holds and rotates a single substrate W in a horizontal orientation. The nozzle 22 discharges the processing liquid toward the substrate W held by the spin chuck 21. The nozzle 22 may discharge the processing liquid toward the substrate W that is rotating. Also, the nozzle 22 may supply a gas toward the substrate W.

As shown in FIG. 2 and FIG. 3, the plurality of substrate processing portions MC form a plurality of towers TW that are positioned such as to surround the center robot CR in plan view. In the present preferred embodiment, the plurality of towers TW include a first tower TW1 to a fourth tower TW4 (four towers TW). Each tower TW includes a plurality of substrate processing portions MC (here, three substrate processing portions MC) that are stacked vertically.

Next, the chemical liquid cabinets CC shall be described. The chemical liquid cabinets CC house a chemical liquid. The chemical liquid cabinets CC supply the chemical liquid to the substrate processing portions MC. Specifically, as shown in FIG. 2, the first chemical liquid cabinet CC1 supplies the chemical liquid to the substrate processing portions MC that constitute the first tower TW1 and the second tower TW2. The second chemical liquid cabinet CC2 supplies the chemical liquid to the substrate processing portions MC that constitute the third tower TW3 and the fourth tower TW4.

In detail, a piping P1 is connected to each chemical liquid cabinet CC. The piping P1 makes the chemical liquid flow from a utility facility of a plant in which the substrate processing apparatus 200 is installed to the chemical liquid cabinet CC. When the chemical liquid is an aqueous solution, a piping P2 is further connected to the chemical liquid cabinet CC. The piping P2 makes pure water (for example, deionized water) flow from the utility facility of the plant in which the substrate processing apparatus 200 is installed to the chemical liquid cabinet CC. The substrate processing apparatus 200 further includes an opening/closing valve (not shown) positioned in the piping P1. The controller 300 controls an opening/closing state of the opening/closing valve and controls supply of the chemical liquid and supply stop of the chemical liquid to the chemical liquid cabinet CC. When the chemical liquid is the aqueous solution, the substrate processing apparatus 200 further includes an opening/closing valve (not shown) positioned in the piping P2. The controller 300 controls an opening/closing state of the opening/closing valve and controls supply of pure water and supply stop of pure water to the chemical liquid cabinet CC.

As shown in FIG. 3, each chemical liquid cabinet CC may include a storing portion 3, a temperature controlling unit 4, and a pump 5. The storing portion 3 stores the chemical liquid. The temperature controlling unit 4 controls a temperature of the chemical liquid. The pump 5 delivers the chemical liquid to the substrate processing portions MC.

Next, the substrate processing apparatus 200 shall be described further. As shown in FIG. 3, the substrate processing apparatus 200 may further include a drain piping 6 and an opening/closing valve 7. One end of the drain piping 6 is connected to the storing portion 3. The opening/closing valve 7 is positioned in the drain piping 6.

The controller 300 controls an opening/closing state of the opening/closing valve 7. For example, the controller 300 controls the opening/closing state of the opening/closing valve 7 when the chemical liquid inside the storing portion 3 is exchanged with a fresh liquid.

Specifically, the controller 300 makes the opening/closing valve 7 transition from a closed state to an open state to drain the chemical liquid inside the storing portion 3 via the drain piping 6. When the storing portion 3 becomes empty, the controller 300 makes the opening/closing valve 7 transition from the open state to the close state. Thereafter, the controller 300 makes the opening/closing valve (not shown) installed in the piping P1 shown in FIG. 2 transition from a closed state to an open state. Consequently, the chemical liquid is supplied from the utility facility of the plant to the storing portion 3. When the chemical liquid is an aqueous solution, the controller 300 further makes the opening/closing valve (not shown) installed in the piping P2 shown in FIG. 2 transition from a closed state to an open state. Consequently, the pure water is supplied from the utility facility of the plant to the storing portion 3.

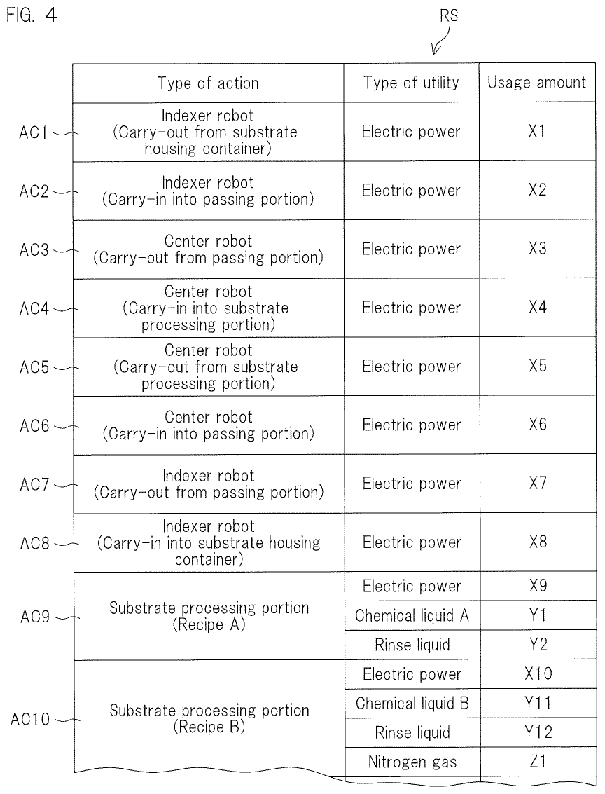

Next, the actions of the respective constituent elements of the substrate processing apparatus 200 and the utility information RS shall be described with reference to FIG. 1 to FIG. 4. FIG. 4 is a diagram showing an example of the utility information RS. As shown in FIG. 4, the utility information RS associates the actions of the respective constituent elements of the substrate processing apparatus 200, the types of the utilities, and the usage amounts of the utilities.

First, the actions of the respective constituent elements of the substrate processing apparatus 200 shall be described. As shown in FIG. 4, the actions of the respective constituent elements of the substrate processing apparatus 200 may include, for example, actions AC1 to AC10.

The action AC1 indicates an action of the indexer robot IR carrying out a substrate W before processing from the substrate housing container C. The action AC2 indicates an action of the indexer robot IR carrying the substrate W before processing into the passing portion PASS. The action AC3 indicates an action of the center robot CR carrying out the substrate W before processing from the passing portion PASS. The action AC4 indicates an action of the center robot CR carrying the substrate W before processing into a substrate processing portion MC. The action AC5 indicates an action of the center robot CR carrying out the substrate W after processing from the substrate processing portion MC. The action AC6 indicates an operation of the center robot CR carrying the substrate W after processing into the passing portion PASS. The action AC7 indicates an action of the indexer robot IR carrying out the substrate W after processing from the passing portion PASS. The action AC8 indicates an action of the indexer robot IR carrying the substrate W after processing into the substrate housing container C. The action AC9 indicates an action of the substrate processing portion MC processing the substrate W based on a recipe A. The action AC10 indicates an action of the substrate processing portion MC processing the substrate W based on a recipe B.

It is noted that the substrate processing portion MC uses a chemical liquid A and the rinse liquid when processing the substrate W based on the recipe A. Also, the substrate processing portion MC uses a chemical liquid B, the rinse liquid, and nitrogen gas when processing the substrate W based on the recipe B.

Next, the utility information RS shall be described. The utility information RS indicates the types and the usage amounts of the utilities according to action units of the respective constituent elements of the substrate processing apparatus 200. That is, the utility information RS indicates the types and the usage amounts of the utilities used in the respective actions. As shown in FIG. 4, the utility used by the indexer robot IR and the center robot CR is electric power (actions AC1 to AC8). The utilities that the substrate processing portion MC uses in processing the substrate W based on the recipe A are electric power, chemical liquid A, and rinse liquid (action AC9). The utilities that the substrate processing portion MC uses in processing the substrate W based on the recipe B are electric power, chemical liquid B, rinse liquid, and nitrogen gas (action AC10). The utility information RS may be input, for example, from a removable medium into the computing processing portion 104.

Here, a method for creating the schedule SK shall be described. The computing processing portion 104 creates the schedule SK by positioning, along a time sequence, a plurality of blocks BL that specify contents of the operations of the substrate processing apparatus 200. The blocks BL correspond to the actions of the respective constituent elements of the substrate processing apparatus 200. For example, the computing processing portion 104 creates the schedule SK by positioning, along the time sequence, the respective blocks BL corresponding to the actions AC1 to AC10 shown in FIG. 4. Specifically, the computing processing portion 104 positions the respective blocks BL in a timetable. As already described, the blocks BL correspond to the actions of the respective constituent elements. The utility information RS thus indicates the usage amounts of the utilities according to each block BL.

Next, a flow of the reinforcement learning shall be described with reference to FIG. 1 to FIG. 5. FIG. 5 is a sequence diagram showing a flow of processes of the reinforcement learning. The computing processing portion 104 constructs the trained model by executing the reinforcement learning based on learning input data that includes the current state of the apparatus, the contents of the processes to be started (contents of the current project PJ), and the utility information RS. As shown in FIG. 5, in the reinforcement learning, processes of step S1 to step S12 are executed repeatedly.

In detail, the computing processing portion 104 creates a list of all actions required for the current project PJ based on the current state of the apparatus and the contents of the processes to be started (contents of the current project PJ) (step S1). In the present preferred embodiment, all actions of the indexer robot IR, all actions of the center robot CR, and all actions of the substrate processing portion MC are included in the list of all actions. Here, all actions include all of the actions until completion of the current project PJ. For example, when N substrates W housed in the substrate housing container C are to be processed in the current project PJ, all actions of the indexer robot IR include N actions AC1 (see FIG. 4).

After creating the list of all actions, the computing processing portion 104 creates a list of next executable actions with reference to the current state of the apparatus and the list of all actions (step S2). Hereinafter, the list of next executable actions is referred to at times as the “list of next actions.” For example, when, in a state where a substrate W to be subject to transfer by the indexer robot IR is housed in the substrate housing container C, the indexer robot IR is not gripping a substrate W, and the substrate W to be subject to transfer by the indexer robot IR is not placed on the passing portion PASS, the actions AC1, AC2, AC7, and AC8 (see FIG. 4) are included in the list of all actions, the computing processing portion 104 acquires just the action AC1, among actions AC1, AC2, AC7, and AC8, as the next executable action.

When creating the list of next actions, the computing processing portion 104 references the utility information RS and acquires the types and the usage amounts of the utilities used in the respective next executable actions. Hereinafter, the types and the usage amounts of the utilities used in the respective next executable actions is referred to at times as the “utilities of the next actions.”

After creation of the list of next actions, the computing processing portion 104 executes a preprocess on input data that includes the respective next executable actions, the current state of the apparatus, and the utilities of the next actions (step S3). By the preprocess, feature values of the input data are extracted. The preprocess may include, for example, at least one of a dimensionality reduction process and a convolution process.

The computing processing portion 104 inputs the input data after the preprocess into a neural network model (step S4). Consequently, the Q values of the respective next executable actions are output from the neural network model. The neural network model is an example of the machine learning model M (reinforcement learning model). the neural network model repeating learning, the prediction model (trained model) is constructed. It is noted that, as shown in FIG. 5, the neural network model may include an input layer, a feature extraction layer (intermediate layer), a connection layer (intermediate layer), and an output layer. In the feature extraction layer, feature values corresponding to a plurality of predetermined evaluation items are extracted. In the connection layer, the Q values of the respective evaluation items are connected.

The computing processing portion 104 executes a postprocess on the Q values output from the neural network model and calculates evaluation values of the respective next executable actions (step S5). The Q values of the plurality of evaluation items are reflected in the evaluation values.

The computing processing portion 104 determines, from among the next executable actions, a next action to be executed (step S6). The computing processing portion 104 may determine the next action to be executed based, for example, on an ϵ (epsilon)—greedy method. In this case, the next action to be executed is selected randomly at initial learning. Specifically, when a value of ϵ (epsilon) is greater than a predetermined value, the computing processing portion 104 selects the next action to be executed at random. When the value of ϵ (epsilon) becomes equal to or less than the predetermined value, the computing processing portion 104 selects an action of the greatest evaluation value among the next executable actions as the next action to be executed.

Upon determining the next action to be executed, the computing processing portion 104 positions the block BL corresponding to the determined action along the time sequence in the timetable and renews the timetable. Consequently, the determined action becomes an executed action.

When the timetable is renewed, the computing processing portion 104 renews the current state of the apparatus to the state after execution of the determined action (step S7). Also, upon renewing the timetable, the computing processing portion 104 deletes the executed action from the list of all actions required for the current project PJ and renews the list of all actions (step S8).

The computing processing portion 104 repeats the series of processes of step S1 to step S8 until all of the actions are deleted from the list of all actions required for the current project PJ. Consequently, the schedule SK is created (step S9). The computing processing portion 104 displays the created schedule SK on the display portion 102.

Also, the computing processing portion 104 calculates the reward (initial reward) to be provided to the created schedule SK (step S10). Specifically, the computing processing portion 104 calculates the initial reward based on the evaluation values calculated in the post-process (step S5).

The worker checks the schedule SK displayed on the display portion 102 and manipulates the inputting portion 101 to input the additional reward. Consequently, the final reward is calculated by the computing processing portion 104 (step S11). The additional reward is input by the worker based on an intended use of the schedule creating program that is currently created. For example, the worker may decide the value of the additional reward in accordance with the evaluation items set for calculating the Q values in the neural network model.

After calculation of the final reward, the computing processing portion 104 adjusts weighting factors of the neural network model based on the final reward (step S12). Consequently, the weighting factors of the evaluation items set for calculating the Q values in the neural network model are adjusted. Specifically, the computing processing portion 104 adjusts the weighting factors of the evaluation items such that the evaluation values of the respective actions calculated in the post-process (step S5) become values matching the final reward.

After adjusting the weighting factors, the computing processing portion 104 executes the processes of step S1 to step S12 and adjusts the weighting factors again. Specifically, the computing processing portion 104 repeats the processes of step S1 to step S12 until the evaluation values of the respective actions calculated in the post-process (step S5) become values matching the initial reward.

Next, the evaluation items provided to the machine learning model M shall be described with reference to FIG. 1 to FIG. 5. In the example shown in FIG. 5, the evaluation items provided to the machine learning model M are the evaluation items set to calculate the Q values in the neural network model. The evaluation items provided to the machine learning model M are changed in accordance with the intended use of the schedule creating program.

In detail, the worker uses the learning device 100 to generate the plurality of schedule creating programs. The plurality of schedule creating programs respectively create schedules SK differing from each other in the usage amounts of the utilities. In the present preferred embodiment, the worker uses the learning device 100 to generate a first schedule creating program to a fourth schedule creating program.

The first schedule creating program is a program that creates a schedule SK that prioritizes throughput. The second schedule creating program is a program that creates a schedule SK that disperses peaks of utilities. The third schedule creating program is a program that creates a schedule SK with which the usage amounts of the utilities are made less than the first schedule creating program. The fourth schedule creating program is a program that creates a schedule SK with which the usage amounts of the utilities are made less than the first schedule creating program.

Hereinafter, the schedule SK created by the first schedule creating program is referred to at times as a “first schedule SK1.” Similarly, the schedules SK created by the second schedule creating program to the fourth schedule creating program are respectively referred to at times as a “second schedule SK2” to a “fourth schedule SK4.” The evaluation item in the creation of the first schedule creating program is just the throughput. Therefore, the evaluation values and the reward (initial reward) are greater when the end time of the schedule SK is an earlier time. It is noted that, in creating the first schedule creating program, the worker does not have to input the additional reward.

The evaluation items in the creation of the second schedule creating program are the throughput and the peaks of the usage amounts of the utilities. The worker increases the value of the additional reward when the peaks of the usage amounts of the utilities are more dispersed. Consequently, weighting factors for the peaks of the usage amounts of the utilities increase and the more dispersed the peaks of the usage amounts of the utilities, the greater the evaluation values and the reward (initial reward). The second schedule SK2 is thus made smaller in peak values of the usage amounts of the utilities in comparison to the first schedule SK1. It is noted that the computing processing portion 104 may decrease a weighting factor for the throughput as the weighting factors for the peaks of the usage amounts of the utilities increase.

The evaluation items in the creation of the third schedule creating program are the throughput, the number of times of transfer of the substrate W by the indexer robot IR, and the number of times of transfer of the substrate W by the center robot CR. Hereinafter, the number of times of transfer of the substrate W by the indexer robot IR and the number of times of transfer of the substrate W by the center robot CR are referred to at times as the “number of times of transfer by the transferring portions.”

The worker increases the additional reward when the number of times of transfer by the transferring portions is fewer. Consequently, a weighting factor for the number of times of transfer by the transferring portions is increased and the fewer the number of times of transfer by the transferring portions, the greater the evaluation values and the reward (initial reward). Thus, in comparison to the first schedule SK1, the third schedule SK3 is fewer in the number of times of operation of the indexer robot IR and the center robot CR. By reducing the number of times of transfer of the substrate W by the indexer robot IR and the center robot CR, the usage amount of electric power can be suppressed. It is noted that the computing processing portion 104 may decrease the weighting factor for the throughput as the weighting factor for the number of times of transfer by the transferring portions increases.

The evaluation items in the creation of the third schedule creating program may further include the number of times the chemical liquid is switched in the chemical liquid cabinets CC. Hereinafter, the number of times the chemical liquid is switched in the chemical liquid cabinets CC is referred to at times as the “number of times of chemical liquid switching.”

The worker increases the additional reward when the number of times of chemical liquid switching is fewer. Consequently, a weighting factor for the number of times of chemical liquid switching is increased and the fewer the number of times of chemical liquid switching, the greater the evaluation values and the reward (initial reward). By reducing the number of times of chemical liquid switching, the usage amount of the chemical liquid can be suppressed. The third schedule SK3 can thus suppress the usage amounts of the utilities in comparison to the first schedule SK1. It is noted that the computing processing portion 104 may decrease the weighting factor for the throughput as the weighting factor for the number of times of chemical liquid switching increases.

The evaluation items in the creation of the fourth schedule creating program are the throughput and the number of parallel units. Here, the parallel units indicate the number of substrate processing portions MC that process the substrates W in the current project PJ.

The worker increases the additional reward when the number of substrate processing portions MC used in the current project PJ is fewer. Consequently, a weighting factor for the number of parallel units is increased and the fewer the number of parallel units, the greater the evaluation values and the reward (initial reward). Thus, in comparison to the first schedule SK1, the fourth schedule SK4 makes a fewer number of the substrate processing portions MC process the substrates W. By reducing the number of substrate processing portions MC used, the number of substrate processing portions MC that execute the preprocess and the postprocess based on the pre-recipe and the post-recipe is reduced and therefore, the usage amount of electric power and the usage amount of pure water can be suppressed. It is noted that the computing processing portion 104 may decrease the weighting factor for the throughput as the weighting factor for the number of parallel units increases.

The evaluation items in the creation of the fourth schedule creating program may include a length of a period in which each substrate processing portion MC is not processing a substrate W. Hereinafter, the length of the period in which the substrate processing portion MC is not processing a substrate W is referred to at times as the “rest period of substrate processing portion MC.”

The worker provides the additional reward when the rest period of substrate processing portion MC is shorter than a fixed time. Consequently, a weighting factor for the rest period of substrate processing portion MC is increased and when the rest period of substrate processing portion MC is shorter than the fixed time, the evaluation values and the reward (initial reward) increase. Thus, in comparison to the first schedule SK1, the rest period of substrate processing portion MC tends to be shorter than the fixed time with the fourth schedule SK4. By making the rest period of substrate processing portion MC shorter than the fixed time, the usage amounts of the utilities can be reduced.

In detail, when the rest period of a certain substrate processing portion MC becomes equal to or greater than the fixed time, the controller 300 makes that substrate processing portion MC execute processing of a dummy substrate. Consequently, the usage amounts of the utilities increase. Therefore, by making the rest period of substrate processing portion MC shorter than the fixed time, the number of times of processing of the dummy substrate can be reduced and the usage amounts of the utilities can be suppressed. It is noted that the computing processing portion 104 may decrease the weighting factor for the throughput as the weighting factor for the rest period of substrate processing portion MC increases.

The evaluation items in the creation of the fourth schedule creating program may include the number of times of the cleaning process of the interior of the chamber 2a. Hereinafter, the cleaning process of the interior of the chamber 2a is referred to at times as the “chamber cleaning.” The chamber cleaning is an example of a “specific process.”

In detail, each substrate processing portion MC repeats the chamber cleaning at every first predetermined time (fixed time). Specifically, after the first predetermined time has elapsed from the previous chamber cleaning, the substrate processing portion MC executes the next chamber cleaning in a period in which processing of a substrate W is not executed. Therefore, even after the first predetermined time has elapsed from the previous chamber cleaning, the substrate processing portion MC does not execute the next chamber cleaning while processing of the substrate W is executed in continuation. The number of times of chamber cleaning can thus be judged by whether or not processing of the substrate W is continued by the substrate processing portion MC for which the first predetermined time has elapsed from the previous chamber cleaning. Hereinafter, the substrate processing portion MC for which the first predetermined time has elapsed from the previous chamber cleaning is referred to at times as the “substrate processing portion MC to be cleaned.”

The worker provides the additional reward when processing of the substrate W by the substrate processing portion MC to be cleaned is executed in continuation. Consequently, a weighting factor for the number of times of chamber cleaning is increased and the fewer the number of times of chamber cleaning, the greater the evaluation values and the reward (initial reward). Thus, in comparison to the first schedule SK1, the fourth schedule SK4 is reduced in the number of times of chamber cleaning. Since the usage amounts of the utilities increase when the chamber cleaning is executed, the usage amounts of the utilities can be suppressed by reducing the number of times of chamber cleaning. It is noted that the computing processing portion 104 may decrease the weighting factor for the throughput as the weighting factor for the number of times of chamber cleaning increases.

Next, the evaluation items in the creation of the fourth schedule creating program shall be described further. Evaluation items can be added further in the creation of the fourth schedule creating program. In detail, evaluation items can be added by including any of the information indicating the connection relationship between the substrate processing portions MC and the chemical liquid cabinets CC, information on the towers TW to which the substrate processing portions MC belong, and position information of the substrate processing portions MC in the learning input data.

Specifically, when the connection relationship between the substrate processing portions MC and the chemical liquid cabinets CC is included in the learning input data, the number of times of exchange of the chemical liquid may be added to the evaluation items. In detail, the controller 300 executes a chemical liquid exchange process each time a second predetermined time (a fixed time) elapses. The chemical liquid exchange process indicates a process by which the chemical liquid in a chemical liquid cabinet CC is exchanged with a fresh liquid. Hereinafter, a chemical liquid cabinet CC for which the second predetermined time has elapsed from the previous chemical liquid exchange process is referred to at times as the “chemical liquid cabinet CC subject to chemical liquid exchange.” Also, a substrate processing portion MC connected to the chemical liquid cabinet CC subject to chemical liquid exchange is referred to at times as the “substrate processing portion MC subject to chemical liquid exchange.”

The controller 300 exchanges the chemical liquid in the chemical liquid cabinet CC subject to chemical liquid exchange with the fresh liquid in a period in which the substrate processing portion MC connected to the chemical liquid cabinet CC subject to chemical liquid exchange is not executing processing of a substrate W. Therefore, even after the second predetermined time has elapsed from the previous chemical liquid exchange process, the next chemical liquid exchange process is not executed while the substrate processing portion MC subject to chemical liquid exchange is continuing processing of the substrate W. The number of times of chemical liquid exchange can thus be judged by whether or not the substrate processing portion MC subject to chemical liquid exchange is continuing processing of the substrate W.

The worker provides the additional reward when the substrate processing portion MC subject to chemical liquid exchange is continuing processing of the substrate W. Consequently, a weighting factor for the number of times of chemical liquid exchange is increased and the fewer the number of times of chemical liquid exchange, the greater the evaluation values and the reward (initial reward). Thus, in comparison to the first schedule SK1, the fourth schedule SK4 is reduced in the number of times of chemical liquid exchange. Since the usage amounts of the utilities increase when the chemical liquid exchange process is executed, the usage amounts of the utilities can be suppressed by reducing the number of times of chemical liquid exchange. It is noted that the computing processing portion 104 may decrease the weighting factor for the throughput as the weighting factor for the number of times of chemical liquid exchange increases.

When the connection relationship between the substrate processing portions MC and the chemical liquid cabinets CC is included in the learning input data, whether or not just a specific chemical liquid cabinet CC is used may be added to the evaluation items. Specifically, whether or not just one of the first chemical liquid cabinet CC1 and the second chemical liquid cabinet CC2 is used may be added to the evaluation items.

Whether or not just the specific chemical liquid cabinet CC is used can be evaluated by judging whether or not a substrate W is processed by just the chemical liquid stored in the specific chemical liquid cabinet CC. That is, the evaluation can be made by judging whether or not the substrate W is processed by just a substrate processing portion MC connected to the specific chemical liquid cabinet CC.

Specifically, whether or not just the specific chemical liquid cabinet CC is used can be evaluated by judging whether or not the substrate W is processed by just the chemical liquid stored in one of the first chemical liquid cabinet CC1 and the second chemical liquid cabinet CC2. That is, the evaluation can be made by judging whether or not the substrate W is processed by just the substrate processing portion MC connected to one of the first chemical liquid cabinet CC1 and the second chemical liquid cabinet CC2.

The worker provides the additional reward when the substrate W is processed by just the chemical liquid stored in one of the first chemical liquid cabinet CC1 and the second chemical liquid cabinet CC2. In other words, the worker provides the additional reward when the substrate W is processed by just the substrate processing portion MC connected to one of the first chemical liquid cabinet CC1 and the second chemical liquid cabinet CC2. Consequently, the evaluation values and the reward (initial reward) increase when just the specific chemical liquid cabinet CC is used. By using just one of the first chemical liquid cabinet CC1 and the second chemical liquid cabinet CC2, the usage amounts of the utilities can be suppressed. The fourth schedule SK4 can thus suppress the usage amounts of the utilities in comparison to the first schedule SK1. It is noted that the computing processing portion 104 may decrease the weighting factor for the throughput as a weighting factor for use of the specific chemical liquid cabinet CC increases.

When the information on the towers TW to which the substrate processing portions MC belong is included in the learning input data, whether or not just a specific tower TW is used may be added to the evaluation items. Specifically, whether or not a substrate W is processed by just a substrate processing portion MC included in the specific tower TW among the four towers TW (the first tower TW1 to the fourth tower TW4) may be added to the evaluation items.

The worker provides the additional reward when the substrate W is processed by just the substrate processing portion MC included in the specific tower TW. Consequently, the evaluation values and the reward (initial reward) increase when just the specific tower TW is used. By using just the specific tower TW among the four towers TW, the usage amounts of the utilities can be suppressed. The fourth schedule SK4 can thus suppress the usage amounts of the utilities in comparison to the first schedule SK1. It is noted that the computing processing portion 104 may decrease the weighting factor for the throughput as a weighting factor for use of the specific tower TW increases.

When the position information of the substrate processing portions MC is included in the learning input data, whether or not a substrate W is processed by a substrate processing portion MC that is lower in up/down direction may be added to the evaluation items.

The worker provides the additional reward when the substrate W is processed by the substrate processing portion MC of lower position. Consequently, the evaluation values and the reward (initial reward) increase when the substrate processing portion MC of lower position is used. By using the substrate processing portion MC of lower position, the electric power amount supplied to the temperature controlling unit 4 and the pump 5 can be suppressed. The fourth schedule SK4 can thus suppress the usage amounts of the utilities in comparison to the first schedule SK1. It is noted that the computing processing portion 104 may decrease the weighting factor for the throughput as a weighting factor for position of the substrate processing portion MC used increases.

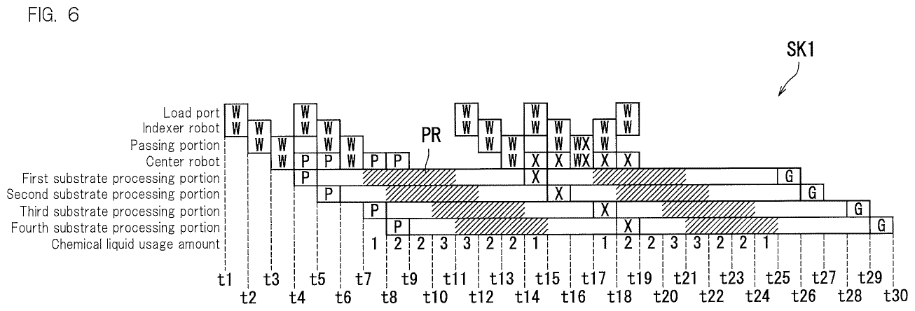

Next an example of the first schedule SK1 to the fourth schedule SK4 shall be described with reference to FIG. 6 to FIG. 13. It is noted that, in FIG. 6 to FIG. 13, “W” indicates an action of transferring two substrates Wat the same time. “P” indicates an action where the center robot CR carries a substrate W into a substrate processing portion MC. “X” indicates an action where the center robot CR interchanges a substrate W that it holds with a substrate W inside a substrate processing portion MC. “WX” indicates an action where two substrates W before processing and two substrates W after processing are interchanged at the passing portion PASS. “G” indicates an action where the center robot CR carries out a substrate W inside a substrate processing portion MC.

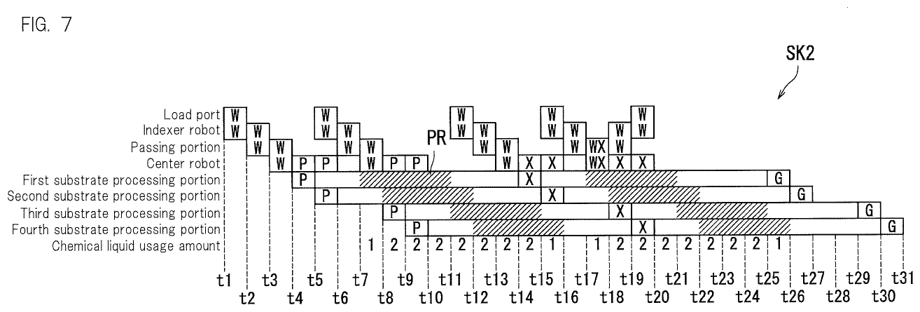

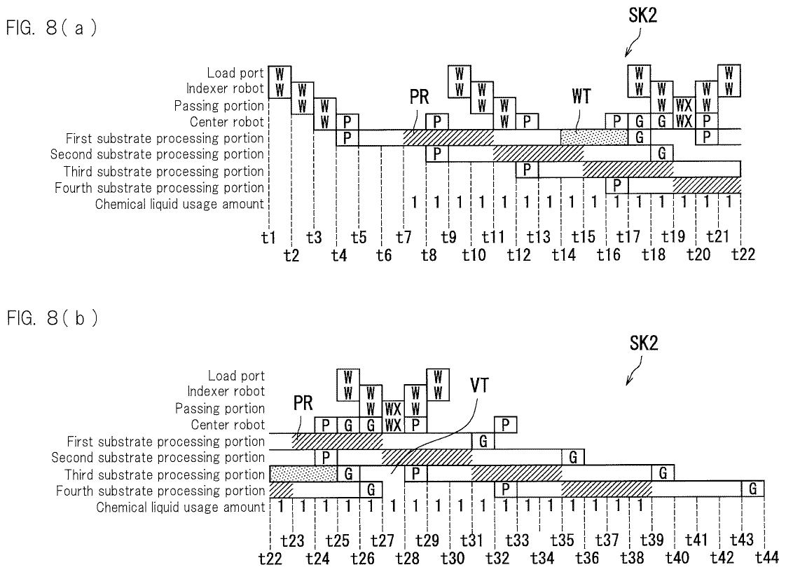

FIG. 6 is a diagram showing a first example of the first schedule SK1. FIG. 7 is a diagram showing an example of the second schedule SK2. FIG. 8(a) and FIG. 8(b) are diagrams showing other examples of the second schedule SK2. In FIG. 6, FIG. 7 and FIG. 8(a) and FIG. 8(b), substrate processing sections PR in each of which a substrate processing portion MC supplies a chemical liquid to a substrate W to process the substrate W are indicated by “hatching.” Also, in FIG. 6, FIG. 7 and FIG. 8(a) and FIG. 8(b), transfer routes of substrates W at the end of the current project PJ are omitted.

In the examples shown in FIG. 6, FIG. 7 and FIG. 8(a) and FIG. 8(b), four substrate processing portions MC (a first substrate processing portion MC1 to a fourth substrate processing portion MC4) are used to process substrates W. It is noted that, in creating the first schedule SK1 and the second schedules SK2 shown in FIG. 6, FIG. 7 and FIG. 8(a) and FIG. 8(b), the information indicating the connection relationship between the substrate processing portions MC and the chemical liquid cabinets CC, the information indicating the towers TW to which the substrate processing portions MC belong, and the position information of the substrate processing portions MC are not included in the learning input data.

As shown in FIG. 6, since the throughput is prioritized in the first schedule SK1, the substrate processing sections PR of the first substrate processing portion MC1 to the fourth substrate processing portion MC4 tend to overlap. Consequently, with the example shown in FIG. 6, three substrate processing sections PR overlap and peak values of the usage amount of the chemical liquid become large (time t10 to time t12 and time t20 to time t22).

On the other hand, as shown in FIG. 7, the second schedule SK2 prioritizes the dispersion of the peaks of the usage amounts of the utilities and therefore the substrate processing sections PR of the first substrate processing portion MC1 to the fourth substrate processing portion MC4 are less likely to overlap in comparison to the first schedule SK1.

Specifically, the second schedule SK2 is dispersed in timings of starts of processing Of the substrates W in comparison to the first schedule SK1. For example, whereas in the first schedule SK1, the substrate processing sections PR begin at time t7, time t8, time t10, and time t11 as shown in FIG. 6, in the second schedule SK2, the substrate processing sections PR begin at time t7, time t8, time t11, and time t12 as shown in FIG. 7.

Consequently, the second schedule SK2 is made smaller in the peak values of the usage amount of the chemical liquid in comparison to the first schedule SK1. For example, with the example shown in FIG. 7, just two substrate processing sections PR overlap even at the maximum (time t8 to time t15 and time t18 to time t25) and the peak values of the usage amount of the chemical liquid are made smaller in comparison to the first schedule SK1 in which three substrate processing sections PR overlap.

It is noted that, as shown in FIG. 6 and FIG. 7, the second schedule SK2 does not place top priority on the throughput and is therefore later in the end time of the current project PJ in comparison to the first schedule SK1.

Next, the other example of the second schedule SK2 shall be described with reference to FIG. 8(a) and FIG. 8(b). In FIG. 8(a) and FIG. 8(b), periods (standby periods WT) in each of which a substrate W is put on standby inside a substrate processing portion MC are indicated by “dot hatching.” It is noted that the second schedule SK2 of FIG. 8(b) shows a continuation of the second schedule SK2 of FIG. 8(a).

In comparison to the second schedule SK2 shown in FIG. 7, the timings of the starts of processing of the substrate W (start timings of the substrate processing sections PR) are dispersed further in the example shown in FIG. 8. Specifically, in the example shown in FIG. 8, overlap of the substrate processing sections PR does not occur. Consequently, in the second schedule SK2 shown in FIG. 8, the peak values of the usage amount of the chemical liquid are decreased further in comparison to the second schedule SK2 shown in FIG. 7.

However, in the second schedule SK2 shown in FIG. 8, the standby periods WT occur. Also, vacant periods VT in which a substrate W is not carried into a substrate processing portion MC occur. Consequently, the throughput decreases significantly and the end time of the current project PJ is delayed significantly. In this case, the worker adjusts the value of the additional reward such that the weighting factor for the peak of the usage amount of the chemical liquid is decreased. Consequently, the second schedule creating program with which the standby period WT and the vacant period VT are unlikely to occur can be generated.

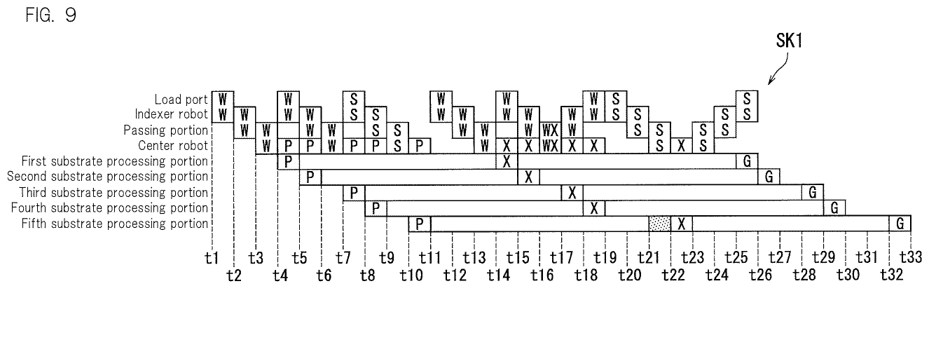

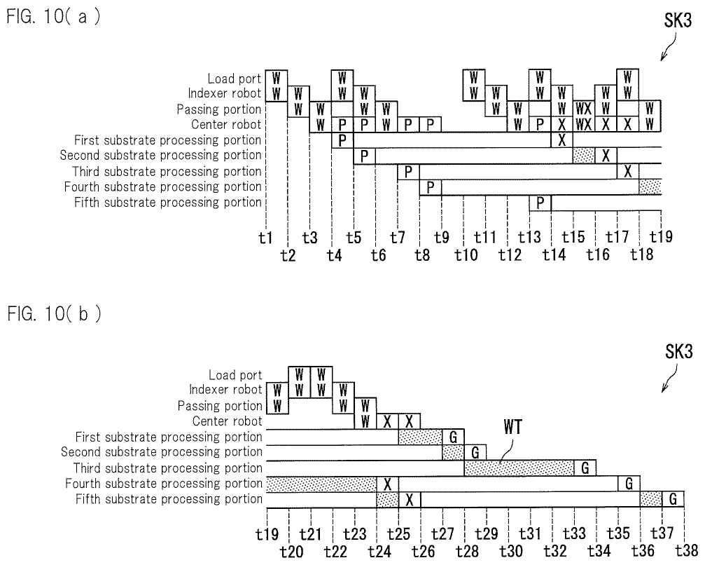

Next, the third schedule SK3 shall be described with reference to FIG. 9, FIG. 10(a), and FIG. 10(b). FIG. 9 is a diagram showing a second example of the first schedule SK1. FIG. 10(a) and FIG. 10(b) are diagrams showing a first example of the third schedule SK3. In FIG. 9, FIG. 10(a), and FIG. 10(b), “S” indicates an action of transferring a single substrate W. Also, in FIG. 9, FIG. 10(a), and FIG. 10(b), the standby periods WT are indicated by “dot hatching.” It is noted that the third schedule SK3 of FIG. 10(b) shows a continuation of the third schedule SK3 of FIG. 10(a).

In the examples shown in FIG. 9, FIG. 10(a), and FIG. 10(b), five substrate processing portions MC (the first substrate processing portion MC1 to a fifth substrate processing portion MC5) are used to process substrates W. It is noted that, in creating the first schedule SK1 and the third schedule SK3 shown in FIG. 9, FIG. 10(a), and FIG. 10(b), the information indicating the connection relationship between the substrate processing portions MC and the chemical liquid cabinets CC, the information indicating the towers TW to which the substrate processing portions MC belong, and the position information of the substrate processing portions MC are not included in the learning input data.

As shown in FIG. 9, when the throughput is prioritized, periods in which the load port LP and the center robot CR transfer a single substrate W occur (for example, time t7 to time t10). On the other hand, as shown in FIG. 10(a) and FIG. 10(b), in the third schedule SK3, the load port LP and the center robot CR always transfer two substrates W at the same time since the number of times of transfer by the transferring portions is prioritized.

As shown in FIG. 9, FIG. 10(a), and FIG. 10(b), by prioritizing the simultaneous transfer of two substrates W, the number of times of operation of the indexer robot IR and the center robot CR is lessened. The third schedule SK3 can thus suppress the usage amount of electric power in comparison to the first schedule SK1.

However, in the third schedule SK3, since top priority is not placed on the throughput and the evaluation values and the reward (initial reward) increase as the number of actions of transferring two substrates W at the same time increases, the standby period WT occurs more readily than in the first schedule SK1. For example, with the fourth substrate processing portion MC4, time t18 to time t24 is the standby period WT.

Next, the third schedule SK3 shall be described with reference to FIG. 11(a) and FIG. 11(b). FIG. 11 (a) is a diagram showing a third example of the first schedule SK1. FIG. 11(b) is a diagram showing a second example of the third schedule SK3. It is noted that, in creating the first schedule SK1 and the third schedule SK3 shown in FIG. 11(a) and FIG. 11(b), the information indicating the connection relationship between the substrate processing portions MC and the chemical liquid cabinets CC, the information indicating the towers TW to which the substrate processing portions MC belong, and the position information of the substrate processing portions MC are not included in the learning input data.

In each of the examples shown in FIG. 11(a) and FIG. 11(b), the process recipe includes a first substrate processing recipe R1, a second substrate processing recipe R2, a first chemical liquid recipe KC1, and a second chemical liquid recipe KC2. Consequently, a substrate processing according to the first substrate processing recipe R1 and the first chemical liquid recipe KC1 and a substrate processing according to the second substrate processing recipe R2 and the second chemical liquid recipe KC2 are executed based on the process recipe.

Specifically, a first chemical liquid is used in the substrate processing according to the first substrate processing recipe R1. Before execution of the substrate processing according to the first substrate processing recipe R1, the first chemical liquid is stored in a chemical liquid cabinet CC based on the first chemical liquid recipe KC1. A second chemical liquid is used in the substrate processing according to the second substrate processing recipe R2. Before execution of the substrate processing according to the second substrate processing recipe R2, the second chemical liquid is stored in the chemical liquid cabinet CC based on the second chemical liquid recipe KC2. The second chemical liquid may, for example, differ in type from the first chemical liquid. Or the second chemical liquid may differ in temperature or concentration from the first chemical liquid. It is noted that, in the following description, the substrate processing according to the first substrate processing recipe R1 is referred to at times as the “first substrate processing.” Also, the substrate processing according to the second substrate processing recipe R2 is referred to at times as the “second substrate processing.”

As shown in FIG. 11(a) and FIG. 11(b), the first substrate processing is executed by the first substrate processing portion MC1 and the second substrate processing portion MC2. The second substrate processing is executed by the third substrate processing portion MC3 and the fourth substrate processing portion MC4.

As shown in FIG. 11(a), in the first schedule SK1, the substrate processing is executed in the order of the first substrate processing, the second substrate processing, the first substrate processing, and the second substrate processing. Thus, switching from the first substrate processing to the second substrate processing occurs twice and at each time, the chemical liquid recipe KC switches from the first chemical liquid recipe KC1 to the second chemical liquid recipe KC2. Also, switching from the second substrate processing to the first substrate processing occurs once. At that point, the chemical liquid recipe KC switches from the second chemical liquid recipe KC2 to the first chemical liquid recipe KC1.

When the chemical liquid recipe KC switches from the first chemical liquid recipe KC1 to the second chemical liquid recipe KC2, a process of switching the chemical liquid inside the chemical liquid cabinet CC from the first chemical liquid to the second chemical liquid occurs. Also, when the chemical liquid recipe KC switches from the second chemical liquid recipe KC2 to the first chemical liquid recipe KC1, a process of switching the chemical liquid inside the chemical liquid cabinet CC from the second chemical liquid to the first chemical liquid occurs. Thus, in the first schedule SK1 shown in FIG. 11(a), the number of times of chemical liquid switching is three.

On the other hand, in the third schedule SK3, the evaluation values and the reward (initial reward) increase as the number of times of chemical liquid switching lessens. Consequently, the number of times of chemical liquid switching becomes less in comparison to the first schedule SK1 as shown in FIG. 11(b). Specifically, as a result of prioritizing the reduction of the number of times of chemical liquid switching, interchange of the order of substrate processing occurs. For example, in the third schedule SK3 shown in FIG. 11(b), the substrate processing is executed in the order of the first substrate processing, the first substrate processing, the second substrate processing, and the second substrate processing. It thus suffices to execute the switching from the first substrate processing to the second substrate processing once and, in comparison to the first schedule SK1, the number of times of chemical liquid switching is reduced. The third schedule SK3 can thus suppress the usage amounts of the utilities in comparison to the first schedule SK1.

It is noted that, in the present preferred embodiment, the substrate processing apparatus 200 includes two chemical liquid cabinets CC (the first chemical liquid cabinet CC1 and the second chemical liquid cabinet CC2). The information indicating the connection relationship between the substrate processing portions MC and the chemical liquid cabinets CC may thus be included in the learning input data input in creating the third schedule creating program. In this case, the third schedule creating program creates the schedule (the third schedule SK3) that makes the first chemical liquid be stored in the first chemical liquid cabinet CC1, the second chemical liquid be stored in the second chemical liquid cabinet CC2, the first substrate processing be executed by the substrate processing portion MC to which the chemical liquid (the first chemical liquid) is supplied from the first chemical liquid cabinet CC1, and the second substrate processing be executed by the substrate processing portion MC to which the chemical liquid (the second chemical liquid) is supplied from the second chemical liquid cabinet CC2. Consequently, the number of times of chemical liquid switching is reduced.

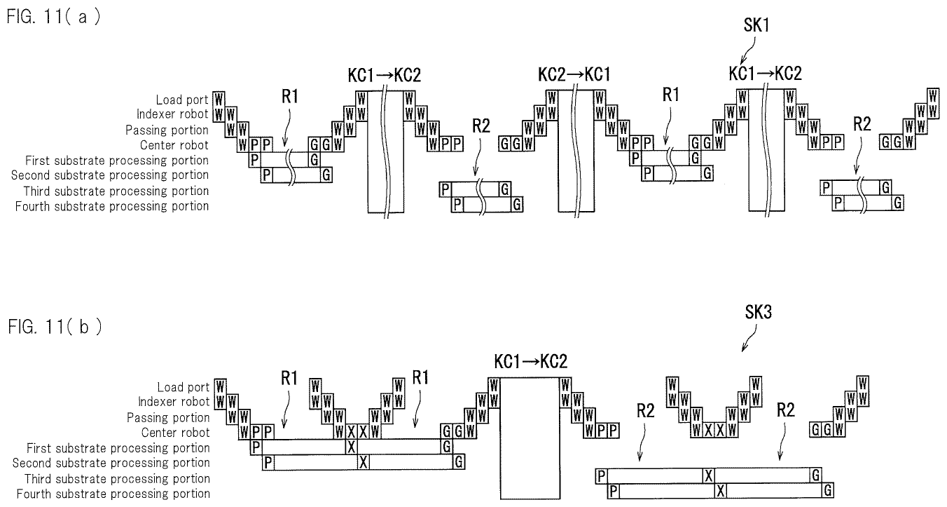

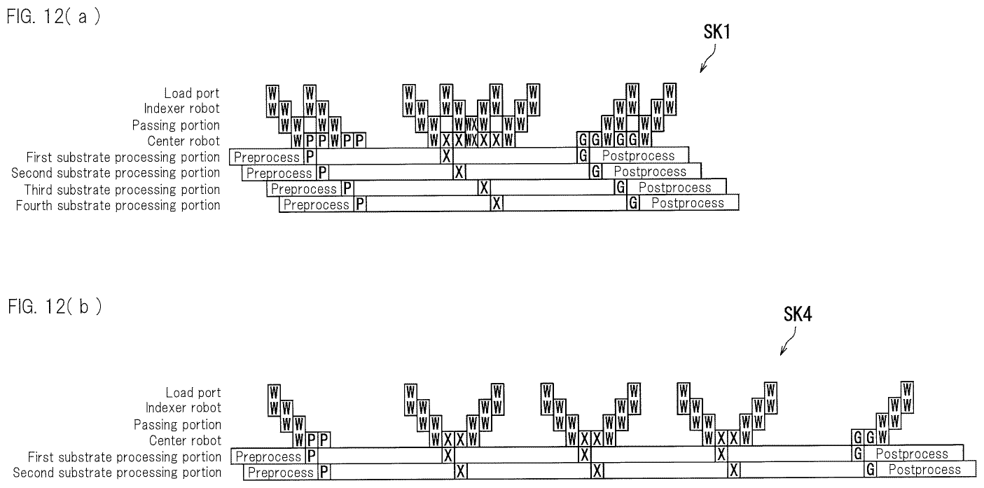

Next, the fourth schedule SK4 shall be described with reference to FIG. 12(a) and FIG. 12(b). FIG. 12 (a) is a diagram showing a fourth example of the first schedule SK1. FIG. 12(b) is a diagram showing a first example of the fourth schedule SK4. It is noted that, in creating the first schedule SK1 and the fourth schedule SK4 shown in FIG. 12(a) and FIG. 12(b), the information indicating the connection relationship between the substrate processing portions MC and the chemical liquid cabinets CC, the information indicating the towers TW to which the substrate processing portions MC belong, and the position information of the substrate processing portions MC are not included in the learning input data.

In each of the examples shown in FIG. 12(a) and FIG. 12(b), a preprocess and a postprocess are executed based on a pre-recipe and a post-recipe. As shown in FIG. 12(a), in the first schedule SK1, the preprocess and the postprocess are executed by each 44 substrate processing portion MC1 to the fourth substrate processing portion MC4. On the other hand, in the fourth schedule SK4, the number of parallel units is reduced since the evaluation values and the reward (initial reward) increase as the number of parallel units decreases.

For example, in the fourth schedule SK4 shown in FIG. 12(b), just the first substrate processing portion MC1 and the second substrate processing portion MC2 among the first substrate processing portion MC1 to the fourth substrate processing portion MC4 execute the substrate processing. Therefore, just the first substrate processing portion MC1 and the second substrate processing portion MC2 among the first substrate processing portion MC1 to the fourth substrate processing portion MC4 execute the preprocess and the postprocess. Consequently, the usage amounts of the utilities are suppressed in comparison to the first schedule SK1.

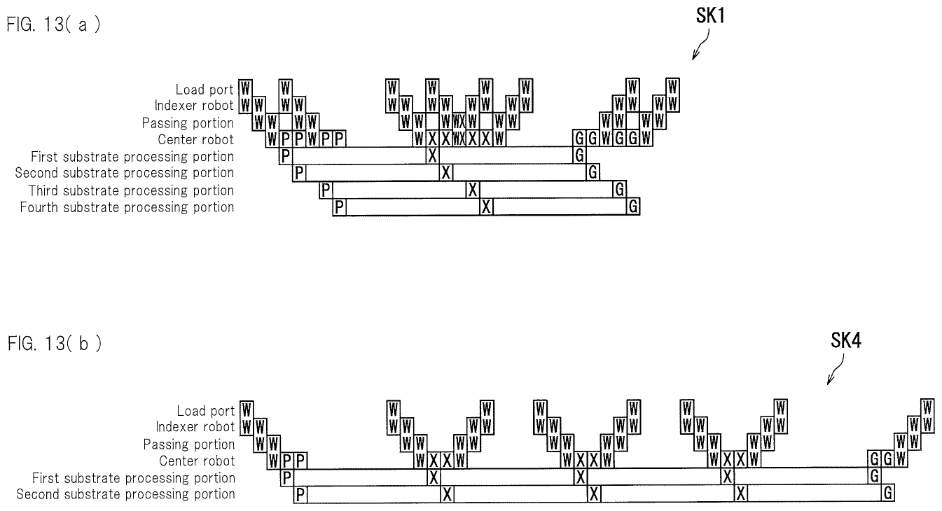

Next, the fourth schedule SK4 shall be described with reference to FIG. 13(a) and FIG. 13(b). FIG. 13(a) is a diagram showing a fifth example of the first schedule SK1. FIG. 13(b) is a diagram showing a second example of the fourth schedule SK4. It is noted that, in creating the fourth schedule SK4 shown in FIG. 13(b), the information indicating the towers TW to which the substrate processing portions MC belong and the position information of the substrate processing portions MC are included in the learning input data.

In each of the examples shown in FIG. 13(a) and FIG. 13(b), the first substrate processing portion MC1 to the fourth substrate processing portion MC4 belong to the same tower TW and are aligned in the order of the first substrate processing portion MC1, the second substrate processing portion MC2, the third substrate processing portion MC3, and the fourth substrate processing portion MC4 from the bottom to top.

As shown in FIG. 13(a), in the first schedule SK1, the first substrate processing portion MC1 to the fourth substrate processing portion MC4 execute the substrate processing. On the other hand, in the fourth schedule SK4, the evaluation values and the reward (initial reward) increase when a substrate processing portion MC of lower position is used. Therefore, in the fourth schedule SK4 shown in FIG. 13(b), just the first substrate processing portion MC1 and the second substrate processing portion MC2 among the first substrate processing portion MC1 to the fourth substrate processing portion MC4 execute the substrate processing. Consequently, the usage amounts of the utilities are suppressed in comparison to the first schedule SK1.

Next, the substrate processing system 1000 of the present preferred embodiment shall be described further with reference to FIG. 2 and FIG. 3. The controller 300 controls the operations of the respective constituent elements of the substrate processing apparatus 200. For example, the controller 300 controls the load port LP, the indexer robot IR, the center robot CR, the plurality of substrate processing portions MC, and the chemical liquid cabinets cc. Also, the controller 300 controls the operation of the substrate housing container C via the load port LP.

Specifically, the controller 300 stores the schedule creating programs created by the learning device 100. The controller 300 creates the schedules SK based on the schedule creating programs and controls the operations of the respective constituent elements of the substrate processing apparatus 200 based on the created schedules SK.

In more detail, the controller 300 stores the plurality of schedule creating programs created by the learning device 100. The controller 300 is capable of creating, based on the plurality of schedule creating programs, a plurality of schedules SK that differ from each other in the usage amounts of the utilities. In the present preferred embodiment, the controller 300 stores the first schedule creating program to the fourth schedule creating program described with reference to FIG. 1 to FIG. 13. For example, the controller 300 creates the first schedule SK1 based on the first schedule creating program.

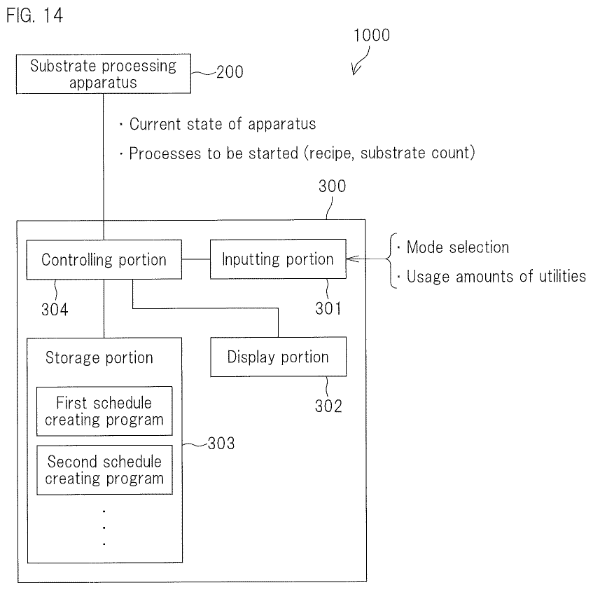

Next, the controller 300 included in the substrate processing system 1000 of the present preferred embodiment shall be described based on FIG. 2, FIG. 3, and FIG. 14. FIG. 14 is a block diagram showing the arrangement of the controller 300 included in the substrate processing system 1000 of the present preferred embodiment.

As shown in FIG. 14, the controller 300 includes an inputting portion 301, a display portion 302, a storage portion 303, and a controlling portion 304.

The inputting portion 301 is a user interface device manipulated by a user. The inputting portion 301 inputs into the controlling portion 304 an instruction (control signal) that is in accordance with the manipulation by the user. Also, the inputting portion 301 inputs into the controlling portion 304 data that is in accordance with the manipulation by the user. The inputting portion 301 may include a keyboard and a mouse. The inputting portion 301 may include a touch sensor superposed on a display surface of the display portion 302. A graphical user interface may be arranged by the touch sensor being superposed on the display surface of the display portion 302. Also, the inputting portion 301 may further include an interface accessible to a removable medium.

For example, the user can manipulate the inputting portion 301 and select an operation mode of the substrate processing apparatus 200. Also, the user can manipulate the inputting portion 301 and input the utility information RS. The utility information RS may also be input into the controlling portion 304 from the removable medium.

The display portion 302 displays various screens or images. For example, the display portion 302 displays a screen for selecting the operation mode of the substrate processing apparatus 200. Also, the display portion 302 may display a schedule SK created based on a schedule creating program. The display portion 302 includes, for example, a display device such as a liquid crystal display device or an organic EL display device.

The storage portion 303 has a main storage device. The main storage device includes, for example, a semiconductor memory. The storage portion 303 further has an auxiliary storage device. The auxiliary storage device includes, for example, at least one of a semiconductor memory and a hard disk drive. The storage portion 303 may include a removable medium.

The storage portion 303 stores various computer programs and various data. The various computer programs include the first schedule creating program to the fourth schedule creating program. The various data include a plurality of recipe information. Specifically, the storage portion 303 stores the plurality of recipe information in association with recipe identification information. Also, the various data include the utility information RS. Specifically, the utility information RS input via the inputting portion 301 is stored in the storage portion 103.

The controlling portion 304 includes a processor. The controlling portion 304 includes, for example, a CPU or an MPU as the processor. Or the controlling portion 304 ma y include a general-purpose computer, a specialized computing unit, a GPU, an NPU, or a quantum computer. The specialized computing unit includes, for example, an ASIC.

The controlling portion 304 executes various processes based on the various programs and various data stored in the storage portion 303. For example, the controlling portion 304 creates the first schedule SK1 based on the first schedule creating program. Specifically, when the substrate housing container C docks into the load port LP, information indicating the current state of the apparatus is input into the controlling portion 304 from the substrate processing apparatus 200. Further, the substrate count information and the recipe identification information are input from the substrate housing container C into the controlling portion 304 via the substrate processing apparatus 200. The controlling portion 304 specifies the recipe information associated with the recipe identification information read out from the substrate housing container C. The controlling portion 304 then creates the schedule SK based on the current state of the apparatus, the specified recipe information, the utility information RS, and the schedule creating program.

In detail, the controlling portion 304 inputs schedule creation input data, which includes the information indicating the current state of the apparatus, the specified recipe information, and the utility information RS, into the trained model included in the schedule creating program. Consequently, the schedule SK is output from the trained model. The trained model creates the schedule SK by positioning, along the time sequence, the plurality of blocks BL that specify the contents of the operations of the substrate processing apparatus 200.

It is noted that, the schedule creation input data may further include any of the information indicating the connection relationship between the substrate processing portions MC and the chemical liquid cabinets CC, the information indicating the towers TW to which the substrate processing portions MC belong, and the position information of the substrate processing portions MC. These information may be stored in advance in the storage portion 303 or may be input by the user manipulating the inputting portion 301.

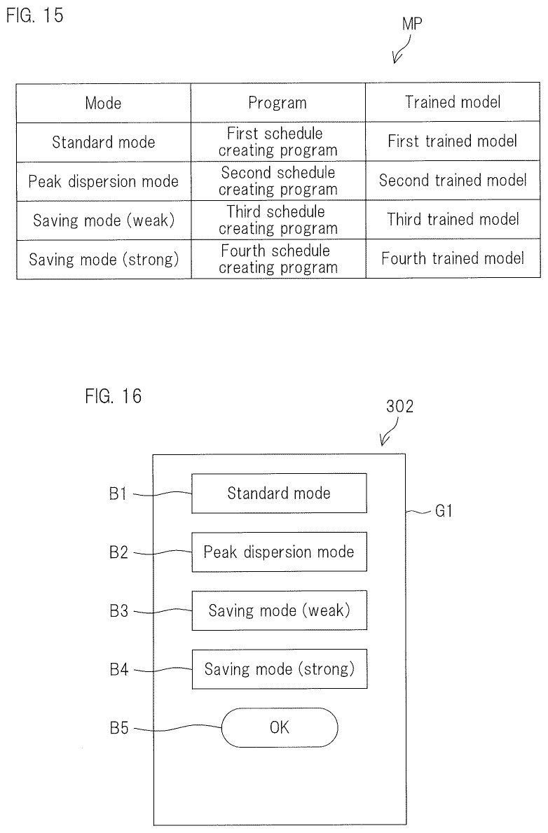

Next, operation modes of the substrate processing apparatus 200 shall be described with reference to FIG. 15. FIG. 15 is a diagram showing mode information MP indicating a relationship between the operation modes of the substrate processing apparatus 200 included in the substrate processing system 1000 of the present preferred embodiment and the schedule creating programs. The mode information MP is stored in the storage portion 303.

As shown in FIG. 15, in the present preferred embodiment, the operation modes of the substrate processing apparatus 200 include a standard mode, a peak dispersion mode, a saving mode (weak), and a saving mode (strong). The standard mode is associated with the first schedule creating program. The peak dispersion mode is associated with the second schedule creating program. The saving mode (weak) is associated with the third schedule creating program. The saving mode (strong) is associated with the fourth schedule creating program.

As shown in FIG. 15, the first schedule creating program includes a first trained model. The first trained model is the prediction model that is constructed when the first schedule creating program is created. Similarly, the second schedule creating program to the fourth schedule creating program respectively include a second trained model to a fourth trained model. The second trained model to the fourth trained model are respectively the prediction models that are constructed when the second schedule creating program to the fourth schedule creating program are created.

Next, a mode selection screen G1 shall be described with reference to FIG. 14 to FIG. 16. FIG. 16 is a diagram showing the mode selection screen G1. As shown in FIG. 16, the display portion 302 displays the mode selection screen G1. For example, the controlling portion 304 makes the display portion 302 display the mode selection screen G1 when the substrate housing container C docks into the load port LP. The mode selection screen Gl is a screen by which the user selects the operation mode of the substrate processing apparatus 200.

In the present preferred embodiment, the mode selection screen G1 displays a first selection button B1 to a fourth selection button B4 and a confirm button B5. The first selection button B1 is a soft button for selecting the standard mode. The second selection button B2 is a soft button for selecting the peak dispersion mode. The third selection button B3 is a soft button for selecting the saving mode (weak) . The fourth selection button B4 is a soft button for selecting the saving mode (strong). The confirm button B5 is a soft button for confirming the selected operation mode.

The user can set the operation mode of the substrate processing apparatus 200 to any of the standard mode, the peak dispersion mode, the saving mode (weak), and the saving mode (strong) by manipulating the inputting portion 301 and pressing any of the first selection button B1 to the fourth selection button B4 and thereafter pressing the confirm button B5.

Specifically, when the user manipulates the inputting portion 301 and presses any of the first selection button B1 to the fourth selection button B4 and thereafter presses the confirm button B5, the controlling portion 304 references the mode information MP and creates the schedule SK based on the schedule creating program associated with the selected operation mode. For example, when the user manipulates the inputting portion 301 and presses the first selection button B1 and thereafter presses the confirm button B5, the controlling portion 304 creates the first schedule SK1 based on the first schedule creating program.

Next, a flow of processes in creating the schedule SK shall be described with reference to FIG. 17. FIG. 17 is a sequence diagram showing the flow of processes in creating the schedule SK.

In creating the schedule SK, the controlling portion 304 creates the schedule SK based on the schedule creation input data including the current state of the apparatus, the contents of the process to be started (the contents of the current project PJ), and the utility information RS and on the schedule creating program selected via the mode selection screen G1. In detail, as shown in FIG. 17, the processes of steps S21 to step S29 are executed in creating the schedule SK.

The respective processes of step S21 to step S29 are substantially the same as the respective processes of step S1 to step S9 described with reference to FIG. 5 and therefore a detailed description shall be omitted here. However, in the process of step S26, an action of the greatest evaluation value among the next executable actions as the next action to be executed.

The neural network model shown in FIG. 17 is the trained model (prediction model). As described with reference to FIG. 1 to FIG. 13, the weighting factors of the neural network model are already adjusted in accordance with the intended use of the schedule creating model. For example, the weighting factors of the neural network model included in the first schedule creating program are adjusted such that the throughput is prioritized. Therefore, when the user selects the standard mode, the schedule SK (the first schedule SK1) in which the throughput is prioritized is created.

Preferred embodiment 1 of the present invention has been described above with reference to FIG. 1 to FIG. 17. According to the present preferred embodiment, the usage amounts of the utilities can be suppressed by just selecting the operation mode of the substrate processing apparatus 200. The time and effort of the worker can thus be saved in comparison to a case of suppressing the usage amounts of the utilities by adjusting the various setting values (the values of the various parameters) of the substrate processing apparatus 200.

Further, according to the present preferred embodiment, the usage amounts of the utilities can be selected in stages. Since the usage amounts of the utilities can thus be changed in stages in accordance with external factors, convenience of the user is improved.

### Preferred Embodiment 2

Next, preferred embodiment 2 of the present invention shall be described with reference to FIG. 1 to FIG. 19. However, matters differing from preferred embodiment 1 shall be described and description of matters that are the same as in preferred embodiment 1 shall be omitted. Preferred embodiment 2 differs from preferred embodiment 1 in processes executed by the controlling portion 304 after the schedule SK is created.

FIG. 18 is a diagram showing a confirmation screen G2 displayed on the display portion 302 included in the substrate processing system 1000 of the present preferred embodiment. The controlling portion 304 makes the display portion 302 display the confirmation screen G2 after creating the schedule SK. As shown in FIG. 18, the confirmation screen G2 displays an end time D1 of the schedule SK, a confirm button B11, and a back button B12.

The end time D1 of the schedule SK indicates the end time of the current project PJ. The confirm button B11 is a soft button for confirming the schedule SK. The back button B12 is a soft button for returning to the mode selection screen G1.

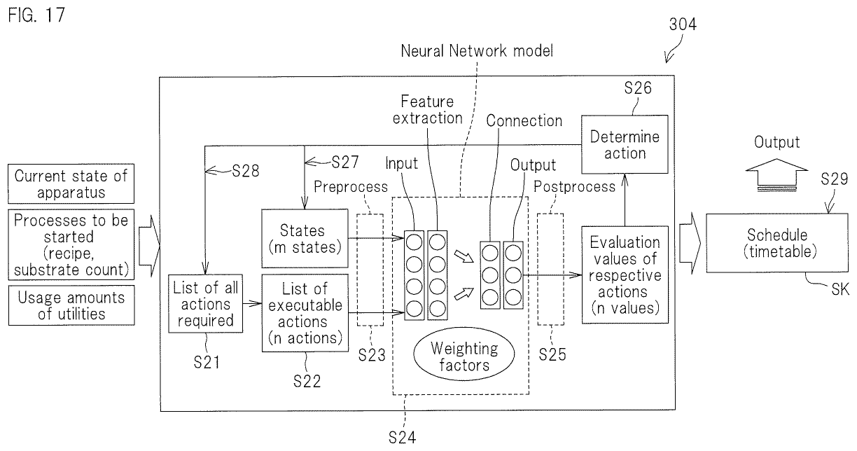

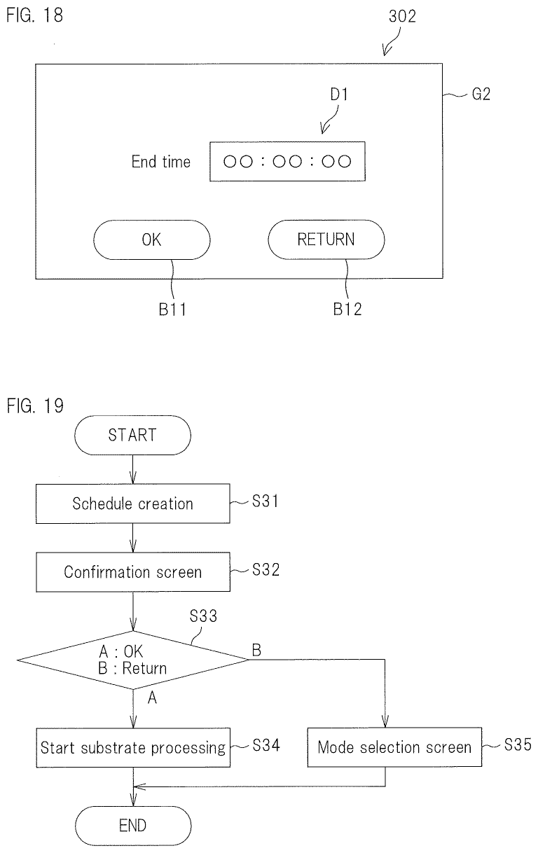

FIG. 19 is a flowchart showing a flow of processes executed by the controlling portion 304 included in the substrate processing system 1000 of the present preferred embodiment. The processes shown in FIG. 19 are started by the operation mode of the substrate processing apparatus 200 being selected in the mode selection screen G1.

As shown in FIG. 19, when the operation mode of the substrate processing apparatus 200 is selected in the mode selection screen G1, the controlling portion 304 creates the schedule SK (step S31).

Upon creating the schedule SK, the controlling portion 304 makes the display portion 302 display the confirmation screen G2 (step S32).

After making the display portion 302 display the confirmation screen G2, the controlling portion 304 judges whether the soft button pressed by the user by manipulating the inputting portion 301 is the confirm button B11 or the back button B12 (step S33). For example, the user may visually check the confirmation screen G2 to confirm the end time D1 of the schedule SK and manipulate the inputting portion 301 to press the confirm button B11 if the end time D1 is a time within an allowable range. Also, the user may manipulate the inputting portion 301 and press the back button B12 if the end time D1 is a time outside the allowable range.

If the user pressed the confirm button B11 (A of step S33), the controlling portion 304 makes the substrate processing apparatus 200 start processing of the substrates W (step S34). Consequently, the processes shown in FIG. 19 end. In this case, the controlling portion 304 controls the operations of the substrate processing apparatus 200 based on the created schedule SK.

On the other hand, if the user presses the back button B12 (B of step S33), the controlling portion 304 makes the display portion 302 display the mode selection screen G1 (step S35) and ends the processes shown in FIG. 19.

Preferred embodiment 2 of the present invention has been described above with reference to FIG. 1 to FIG. 19. According to the present preferred embodiment, when the end time of the schedule SK is a time outside the allowable range, the user can reselect the operation mode of the substrate processing apparatus 200 such that the end time of the schedule SK becomes a time within the allowable range. The convenience of the user is thus improved.

### Preferred Embodiment 3

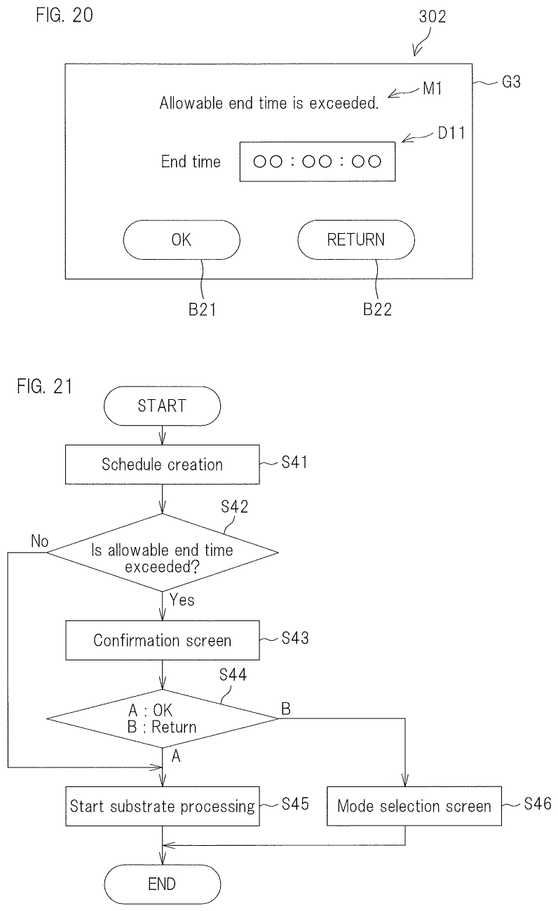

Next, preferred embodiment 3 of the present invention shall be described with reference to FIG. 1 to FIG. 17, FIG. 20, and FIG. 21. However, matters differing from preferred embodiments 1 and 2 shall be described and description of matters that are the same as in preferred embodiments 1 and 2 shall be omitted. Preferred embodiment 3 differs from preferred embodiments 1 and 2 in processes executed by the controlling portion 304 after the schedule SK is created.

FIG. 20 is a diagram showing a confirmation screen G3 displayed on the display portion 302 included in the substrate processing system 1000 of the present preferred embodiment. The controlling portion 304 makes the display portion 302 display the confirmation screen G3 after creating the schedule SK. As shown in FIG. 20, the confirmation screen G3 displays a message M1, an end time D11 of the schedule SK, a confirm button B21, and a back button B22.

The confirmation screen G3 differs from the confirmation screen G2 shown in FIG. 18 in the point of further including the message M1. The message M1 notifies that the end time D11 of the schedule SK exceeds an allowable end time. In other words, the message M1 notifies that the end time D11 of the schedule SK is a time outside the allowable range. The user can visually check the message M1 and confirm that the end time D11 of the schedule SK is an end time outside the allowable range. The allowable end time is stored in advance in the storage portion 303. In detail, the user manipulates the inputting portion 301 and inputs the allowable end time.

FIG. 21 is a flowchart showing a flow of processes executed by the controlling portion 304 included in the substrate processing system 1000 of the present preferred embodiment. The processes shown in FIG. 21 are started by the operation mode of the substrate processing apparatus 200 being selected in the mode selection screen G1.

As shown in FIG. 21, when the operation mode of the substrate processing apparatus 200 is selected in the mode selection screen G1, the controlling portion 304 creates the schedule SK (step S41).

Upon creating the schedule SK, the controlling portion 304 judges whether or not the end time of the schedule SK exceeds the allowable end time (step S42).

If the controlling portion 304 judges that the end time of the schedule SK exceeds the allowable end time (Yes in step S42), it makes the display portion 302 display the confirmation screen G3 (step S43).

After making the display portion 302 display the confirmation screen G3, the controlling portion 304 judges whether the soft button pressed by the user by manipulating the inputting portion 301 is the confirm button B21 or the back button B22 (step S44). For example, if execution of substrate processing is desired despite the end time D11 being a time outside the allowable range, the user may manipulate the inputting portion 301 and press the confirm button B21. Or, the user may manipulate the inputting portion 301 and press the back button B22 since the end time D11 is a time outside the allowable range.

If the user pressed confirm button B21 (A of step S44), the controlling portion 304 makes the substrate processing apparatus 200 start processing of the substrates W (step S45). Consequently, the processes shown in FIG. 21 end. In this case, the controlling portion 304 controls the operations of the substrate processing apparatus 200 based on the created schedule SK. Or, if the controlling portion 304 judges that the end time of the schedule SK does not exceed the allowable end time (No in step S42), it makes the substrate processing apparatus 200 start processing of the substrates W (step S45).

On the other hand, if the user presses the back button B22 (B of step S44), the controlling portion 304 makes the display portion 302 display the mode selection screen G1 (step S46) and ends the processes shown in FIG. 21.

Preferred embodiment 3 of the present invention has been described above with reference to FIG. 1 to FIG. 17, FIG. 20, and FIG. 21. According to the present preferred embodiment, when the end time of the schedule SK is a time outside the allowable range, the user can reselect the operation mode of the substrate processing apparatus 200 such that the end time of the schedule SK becomes a time within the allowable range. The convenience of the user is thus improved.

### Preferred Embodiment 4

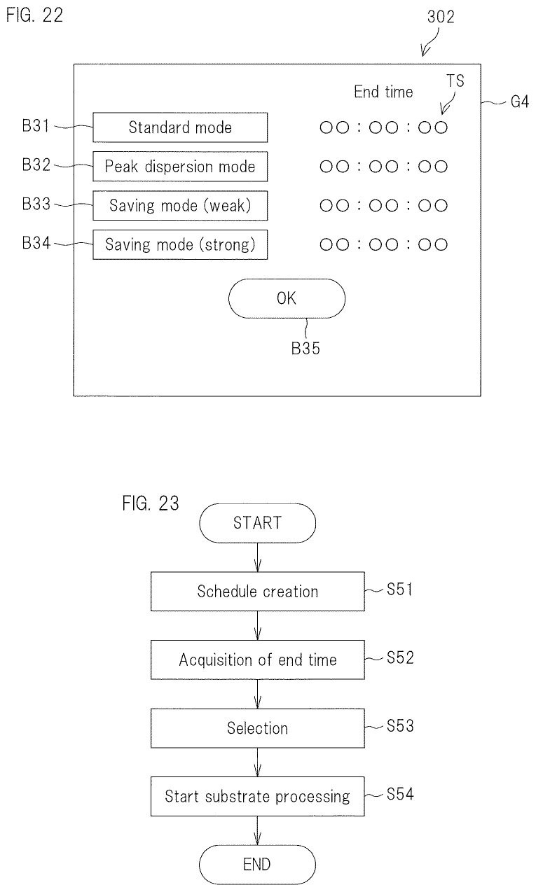

Next, preferred embodiment 4 of the present invention shall be described with reference to FIG. 1 to FIG. 15, FIG. 17, and FIG. 22. However, matters differing from preferred embodiments 1 to 3 shall be described and description of matters that are the same as in preferred embodiments 1 to 3 shall be omitted. Preferred embodiment 4 differs from preferred embodiments 1 to 3 in processes executed by the controlling portion 304 in creating the schedule SK.

FIG. 22 is a diagram showing a mode selection screen G4 displayed on the display portion 302 included in the substrate processing system 1000 of the present preferred embodiment. The controlling portion 304 makes the display portion 302 display the mode selection screen G4, for example, when the substrate housing container C docks into the load port LP.

In detail, when the substrate housing container C docks into the load port LP, the controlling portion 304 creates the first schedule SK1 to the fourth schedule SK4 based on the first schedule creating program to the fourth schedule creating program and acquires respective end times of the first schedule SK1 to the fourth schedule SK4. After acquiring the respective end times of the first schedule SK1 to the fourth schedule SK4, the controlling portion 304 makes the display portion 302 display the mode selection screen G4.

As shown in FIG. 22, the mode selection screen G4 displays a first selection button B31 to a fourth selection button B34, a confirm button B35, and an end time notification column TS. The mode selection screen G4 differs from the mode selection screen G1 shown in FIG. 16 in the point of further including the end time notification column TS. The end time notification column TS notifies the end time of the schedule SK when the substrate processing apparatus 200 operates in the standard mode, the end time of the schedule SK when the substrate processing apparatus 200 operates in the peak dispersion mode, the end time of the schedule SK when the substrate processing apparatus 200 operates in the saving mode (weak), and the end time of the schedule SK when the substrate processing apparatus 200 operates in the saving mode (strong). In other words, the end time notification column TS notifies the respective end times of the first schedule SK1 to the fourth schedule SK4.

Preferred embodiment 4 of the present invention has been described above with reference to FIG. 1 to FIG. 15, FIG. 17, and FIG. 22. According to the present preferred embodiment, the end times of the respective operation modes are displayed in the mode selection screen G4 and therefore, the user can select the operation mode upon checking the end times of the respective operation modes. The convenience of the user is thus improved.

### Preferred Embodiment 5

Next, preferred embodiment 5 of the present invention shall be described with reference to FIG. 1 to FIG. 15, FIG. 17, and FIG. 23. However, matters differing from preferred embodiments 1 to 4 shall be described and description of matters that are the same as in preferred embodiments 1 to 4 shall be omitted. Preferred embodiment 5 differs from preferred embodiments 1 to 4 in processes executed by the controlling portion 304 in creating the schedule SK.

FIG. 23 is flowchart showing a flow of processes executed by the controlling portion 304 included in the substrate processing system 1000 of the present preferred embodiment. The controlling portion 304 starts the processes shown in FIG. 23, for example, when the substrate housing container C docks into the load port LP.

When the processes shown in FIG. 23 are started, the controlling portion 304 creates the first schedule SK1 to the fourth schedule SK4 based on the first schedule creating program to the fourth schedule creating program (step S51) and acquires the respective end times of the first schedule SK1 to the fourth schedule SK4 (step S52).

After acquiring the respective end times of the first schedule SK1 to the fourth schedule SK4, the controlling portion 304 selects, from among the first schedule SK1 to the fourth schedule SK4, the schedule SK with which the end time is a time within the allowable range and a total amount of the usage amounts of the utilities is minimized (step S53).

Upon selecting the schedule SK, the controlling portion 304 makes the substrate processing apparatus 200 start processing of the substrates W (step S54) and then ends the processes shown in FIG. 23. The controlling portion 304 controls the operations of the substrate processing apparatus 200 based on the schedule SK selected in step S53.

Preferred embodiment 5 of the present invention has been described above with reference to FIG. 1 to FIG. 15, FIG. 17, and FIG. 23. According to the present preferred embodiment, the schedule SK (the operation mode) with which the total amount of the usage amounts of the utilities is minimized is selected from among the schedules SK (the operation modes) with which the end time is within the allowable range. The usage amounts of the utilities can thus be suppressed. Further, with the present preferred embodiment, the operation mode of the substrate processing apparatus 200 with which the total amount of the usage amounts of the utilities is minimized is selected without the user having to perform a manipulation of the selecting the operation mode. The convenience of the user is thus improved.

The preferred embodiments of the present invention have been described above with reference to the drawings (FIG. 1 to FIG. 23). However, the present invention is not limited to the preferred embodiments described above and can be implemented in various modes within a scope not deviating from its gist. Also, it is possible to modify, as appropriate, the plurality of constituent elements disclosed in the preferred embodiments described above. For example, a certain constituent element among all constituent elements of a certain preferred embodiment may be added to the constituent elements of another preferred embodiment or some constituent elements among all constituent elements of a certain preferred embodiment may be deleted from the preferred embodiment.

The drawings mainly illustrate the respective constituent elements schematically to facilitate understanding of the invention and there are cases where thicknesses, lengths, numbers, intervals, etc., of the respective constituent elements illustrated differ from actuality due to convenience of drawing preparation. Also, the arrangements of the respective constituent elements indicated in the preferred embodiments described above are but an example, are not restricted in particular, and can obviously be changed variously within a scope of practically not deviating from the effects of the present invention.

For example, the substrate processing executed by the substrate processing apparatus 200 (the substrate processing portions MC) is not restricted in particular. For example, the substrate processing may be an etching processing, a cleaning processing, a brush cleaning processing, a photosensitive coating processing, a developing processing, an annealing processing, or a drawing processing.

Also, although with the preferred embodiments described with reference to FIG. 1 to FIG. 23, the substrate processing system 1000 stores four types of the schedule creating programs (the first schedule creating program to the fourth schedule creating program), the types of the schedule creating programs is not restricted to four as long as the schedules SK that differ from each other in the usage amounts of the utilities can be created. The substrate processing system 1000 may store two, three, or five or more schedule creating programs that differ from each other in the usage amounts of the utilities.

Also, although with the preferred embodiments described with reference to FIG. 1 to FIG. 23, the substrate processing apparatus 200 is of the single substrate processing type, the substrate processing apparatus 200 may instead be of a batch processing type.

Also, although with the preferred embodiments described with reference to FIG. 1 to FIG. 23, the substrate processing apparatus 200 includes two chemical liquid cabinets CC, the substrate processing apparatus 200 may instead include one or three or more chemical liquid cabinets CC.

### INDUSTRIAL APPLICABILITY

The present invention is useful for an apparatus that processes a substrate and has industrial applicability.

### REFERENCE SIGNS LIST

200: Substrate processing apparatus
300: Controller
303: Storage portion
304: Controlling portion
1000: Substrate processing system
CC: Chemical liquid cabinet
CC1: First chemical liquid cabinet
CC2: Second chemical liquid cabinet
CR: Center robot
D1: End time
D11: End time
IR: Indexer robot
KC: Chemical liquid recipe
KC1: First chemical liquid recipe
KC2: Second chemical liquid recipe
M: Machine learning model
MC: Substrate processing portion
MC1: First substrate processing portion
MC2: Second substrate processing portion
MC3: Third substrate processing portion
MC4: Fourth substrate processing portion
MC5: Fifth substrate processing portion
PJ: Project
PR: Substrate processing section
R: Substrate processing recipe
R1: First substrate processing recipe
R2: Second substrate processing recipe
RS: Utility information
SK: Schedule
SK1: First schedule
SK2: Second schedule
SK3: Third schedule
SK4: Fourth schedule
TW: Tower
TW1: First tower
TW2: Second tower
TW3: Third tower
TW4. Fourth tower
W: Substrate

1. A substrate processing system comprising:
a substrate processing apparatus that uses a utility to process a substrate; and
a controller that is configured or programmed to position, along a time sequence, a plurality of blocks specifying contents of operations of the substrate processing apparatus based on substrate count information indicating a number of the substrates to be processed by the substrate processing apparatus, recipe information specifying a procedure of operations of the substrate processing apparatus, and utility information indicating a usage amount of the utility used in each action included in the procedure of the operations of the substrate processing apparatus, and to create a schedule specifying the operations of the substrate processing apparatus along the time sequence; wherein
the controller includes
a storage portion to store a plurality of trained models for creating a plurality of schedules differing from each other in the usage amount of the utility, and
a controlling portion that is capable of creating the plurality of schedules based on schedule creation input data including the substrate count information, the recipe information, and the utility information and the plurality of trained models;
wherein the plurality of trained models are each constructed by executing reinforcement learning based on learning input data that includes the substrate count information, the recipe information, and the utility information.

2. The substrate processing system according to claim 1, wherein the plurality of schedules include a first schedule and a second schedule, and
in comparison to the first schedule, the second schedule is later in end time.

3. The substrate processing system according to claim 1, wherein the plurality of schedules include a first schedule and a second schedule, and
in comparison to the first schedule, the second schedule is smaller in peak value of the usage amount of the utility.

4. The substrate processing system according to claim 1, wherein the plurality of schedules include a first schedule and a second schedule, and
in comparison to the first schedule, the second schedule is less in total amount of the usage amount of the utility.

5. The substrate processing system according to claim 1, wherein the utility includes at least one of a processing liquid, electric power, and a gas.

6. The substrate processing system according to claim 1, wherein the substrate processing apparatus includes a substrate processing portion to process the substrate, and
the schedule creation input data and the learning input data further include information indicating a position of the substrate processing portion.

7. The substrate processing system according to claim 1, wherein the plurality of schedules include a first schedule and a second schedule, and
in comparison to the first schedule, the second schedule disperses timings of start of processing of a plurality of the substrates by the substrate processing apparatus.

8. The substrate processing system according to claim 1, wherein the plurality of schedules include a first schedule and a second schedule,
the substrate processing apparatus includes
a substrate processing portion that uses a first chemical liquid to process a first substrate and uses a second chemical liquid to process a second substrate, and
a chemical liquid cabinet to store, exclusively of each other, the first chemical liquid and the second chemical liquid supplied to the substrate processing portion, and
in comparison to the first schedule, the second schedule is less in a number of times the first chemical liquid and the second chemical liquid are switched in the chemical liquid cabinet.

9. The substrate processing system according to claim 8, wherein the second chemical liquid differs in type from the first chemical liquid.

10. The substrate processing system according to claim 8, wherein the second chemical liquid differs in temperature or concentration from the first chemical liquid.

10. The substrate processing system according to claim 1, wherein the substrate processing apparatus includes
a first substrate processing portion that uses a first chemical liquid or a second chemical liquid to process the substrate,
a second substrate processing portion that uses the first chemical liquid or the second chemical liquid to process the substrate,
a first chemical liquid cabinet that is capable of storing exclusively the first chemical liquid or the second chemical liquid supplied to the first substrate processing portion, and
a second chemical liquid cabinet that is capable of storing exclusively the first chemical liquid or the second chemical liquid supplied to the second substrate processing portion, and
the plurality of schedules include a schedule that makes the first chemical liquid be supplied from the first chemical liquid cabinet to the first substrate processing portion and the second chemical liquid be supplied from the second chemical liquid cabinet to the second substrate processing portion.

12. The substrate processing system according to claim 11, wherein the second chemical liquid differs in type from the first chemical liquid.

13. The substrate processing system according to claim 11, wherein the second chemical liquid differs in temperature or concentration from the first chemical liquid.

14. The substrate processing system according to claim 1, wherein the plurality of schedules include a first schedule and a second schedule,
the substrate processing apparatus includes a plurality of substrate processing portions to process the substrate, and
in comparison to the first schedule, the second schedule makes a fewer number of the substrate processing portions process the substrate.

15. The substrate processing system according to claim 1, wherein the plurality of schedules include a first schedule and a second schedule,
the substrate processing apparatus includes a substrate processing portion to process the substrate, and
in comparison to the first schedule, the second schedule is shorter in a period in which the substrate processing portion does not process the substrate.

16. The substrate processing system according to claim 1, wherein the substrate processing apparatus includes a substrate processing portion to process the substrate, and
when a fixed time elapses, the substrate processing portion executes a specific process in a period in which the substrate is not processed, and
the plurality of schedules include a schedule that makes the substrate processing portion, for which the fixed time has elapsed, execute processing of the substrate in continuation.

17. The substrate processing system according to claim 1, wherein the substrate processing apparatus includes
a substrate processing portion that uses a chemical liquid to process the substrate, and
a chemical liquid cabinet to store the chemical liquid supplied to the substrate processing portion, and
when a fixed time elapses, the substrate processing apparatus executes an exchange process of the chemical liquid stored in the chemical liquid cabinet, and
the plurality of schedules include a schedule that makes the substrate processing portion execute processing of the substrate in continuation after elapse of the fixed time.

18. The substrate processing system according to claim 1, wherein the plurality of schedules include a first schedule and a second schedule,
the substrate processing apparatus includes a transfer portion to transfer the substrate, and
in comparison to the first schedule, the second schedule is less in a number of times of operation of the transfer portion.

19. The substrate processing system according to claim 1, wherein the substrate processing apparatus includes a plurality of towers,
the plurality of towers each include a plurality of substrate processing portions to process the substrate, and
the plurality of schedules include a schedule that makes the substrate be processed by the substrate processing portion included in a specific tower among the plurality of towers.

20. The substrate processing system according to claim 1, wherein the substrate processing apparatus includes a plurality of chemical liquid cabinets to store a chemical liquid, and
the plurality of schedules include a schedule that makes the substrate be processed by the chemical liquid stored in a specific chemical liquid cabinet among the plurality of chemical liquid cabinets.

21. The substrate processing system according to claim 1, wherein the controlling portion is configured or programmed
to create the plurality of schedules based on the plurality of trained models,
to acquire an end time of each of the plurality of schedules, and
to select from among the plurality of schedules a schedule with which the end time is a time within an allowable range and a total amount of the usage amount of the utility is minimized.

22. A schedule creating method of positioning, along a time sequence, a plurality of blocks specifying contents of operations of a substrate processing apparatus using a utility to process a substrate and creating a schedule that specifies the operations of the substrate processing apparatus along the time sequence,
the schedule creating method comprising: a schedule creating to create at least one of a plurality of schedules differing from each other in usage amount of the utility, based on schedule creation input data including substrate count information indicating a number of the substrates to be processed by the substrate processing apparatus, recipe information specifying a procedure of operations of the substrate processing apparatus, and utility information indicating the usage amount of the utility used in each action included in the procedure of the operations of the substrate processing apparatus and on at least one of a plurality of trained models;
wherein the plurality of trained models are each constructed by executing reinforcement learning based on learning input data that includes the substrate count information, the recipe information, and the utility information.

23. The schedule creating method according to claim 22, wherein the plurality of schedules include a first schedule and a second schedule, and
in comparison to the first schedule, the second schedule is later in end time.

24. The schedule creating method according to claim 22, wherein the plurality of schedules include a first schedule and a second schedule, and
in comparison to the first schedule, the second schedule is smaller in peak value of the usage amount of the utility.

25. The schedule creating method according to claim 22, wherein the plurality of schedules include a first schedule and a second schedule, and
in comparison to the first schedule, the second schedule is less in total amount of the usage amount of the utility.

26. The schedule creating method according to claim 22, wherein the utility includes at least one of a processing liquid, electric power, and a gas.

27. The schedule creating method according to claim 22, wherein the substrate processing apparatus includes a substrate processing portion that processes the substrate, and
the schedule creation input data and the learning input data further include information indicating a position of the substrate processing portion.

28. The schedule creating method according to Claclaim 22, im wherein the plurality of schedules include a first schedule and a second schedule, and
in comparison to the first schedule, the second schedule disperses timings of start of processing of a plurality of the substrates by the substrate processing apparatus.

29. The schedule creating method according to claim 22, wherein the plurality of schedules include a first schedule and a second schedule,
the substrate processing apparatus includes
a substrate processing portion that uses a first chemical liquid to process a first substrate and uses a second chemical liquid to process a second substrate, and
a chemical liquid cabinet to store, exclusively of each other, the first chemical liquid and the second chemical liquid supplied to the substrate processing portion, and
in comparison to the first schedule, the second schedule is less in a number of times the first chemical liquid and the second chemical liquid are switched in the chemical liquid cabinet.

30. The schedule creating method according to claim 29, wherein the second chemical liquid differs in type from the first chemical liquid.

31. The schedule creating method according to claim 29, wherein the second chemical liquid differs in temperature or concentration from the first chemical liquid.

32. The schedule creating method according to claim 22, wherein the substrate processing apparatus includes
a first substrate processing portion that uses a first chemical liquid or a second chemical liquid to process the substrate,
a second substrate processing portion that uses the first chemical liquid or the second chemical liquid to process the substrate,
a first chemical liquid cabinet that is capable of storing exclusively the first chemical liquid or the second chemical liquid supplied to the first substrate processing portion, and
a second chemical liquid cabinet that is capable of storing exclusively the first chemical liquid or the second chemical liquid supplied to the second substrate processing portion, and
the plurality of schedules include a schedule that makes the first chemical liquid be supplied from the first chemical liquid cabinet to the first substrate processing portion and the second chemical liquid be supplied from the second chemical liquid cabinet to the second substrate processing portion.

33. The schedule creating method according to claim 32, wherein the second chemical liquid differs in type from the first chemical liquid.

34. The schedule creating method according to claim 32, wherein the second chemical liquid differs in temperature or concentration from the first chemical liquid.

35. The schedule creating method according to claim 22, wherein the plurality of schedules include a first schedule and a second schedule,
the substrate processing apparatus includes a plurality of substrate processing portions that process the substrate, and
in comparison to the first schedule, the second schedule makes a fewer number of the substrate processing portions process the substrate.

36. The schedule creating method according to claim 22, wherein the plurality of schedules include a first schedule and a second schedule,
the substrate processing apparatus includes a substrate processing portion that processes the substrate, and
in comparison to the first schedule, the second schedule is shorter in a period in which the substrate processing portion does not process the substrate.

37. The schedule creating method according to claim 22, wherein the substrate processing apparatus includes a substrate processing portion that processes the substrate and
when a fixed time elapses, the substrate processing portion executes a specific process in a period in which the substrate is not processed, and
the plurality of schedules include a schedule that makes the substrate processing portion, for which the fixed time has elapsed, execute processing of the substrate in continuation.

38. The schedule creating method according to claim 22, wherein the substrate processing apparatus includes
a substrate processing portion that uses a chemical liquid to process the substrate, and
a chemical liquid cabinet to store the chemical liquid supplied to the substrate processing portion and
when a fixed time elapses, the substrate processing apparatus executes an exchange process of the chemical liquid stored in the chemical liquid cabinet, and
the plurality of schedules include a schedule that makes the substrate processing portion execute processing of the substrate in continuation after elapse of the fixed time.

39. The schedule creating method according to claim 22, wherein the plurality of schedules include a first schedule and a second schedule,
the substrate processing apparatus includes a transfer portion that transfers the substrate, and
in comparison to the first schedule, the second schedule is less in a number of times of operation of the transfer portion.

40. The schedule creating method according to claim 22, wherein the substrate processing apparatus includes a plurality of towers
the plurality of towers each include a plurality of substrate processing portions to process the substrate, and
the plurality of schedules include a schedule that makes the substrate be processed by the substrate processing portion included in a specific tower among the plurality of towers.

41. The schedule creating method according to claim 22, wherein the substrate processing apparatus includes a plurality of chemical liquid cabinets to store a chemical liquid, and
the plurality of schedules include a schedule that makes the substrate be processed by the chemical liquid stored in a specific chemical liquid cabinet among the plurality of chemical liquid cabinets.

42. The schedule creating method according to claim 22, wherein the schedule creating includes
creating the plurality of schedules based on the plurality of trained models,
acquiring an end time of each of the plurality of schedules, and
selecting from among the plurality of schedules a schedule with which the end time is a time within an allowable range and a total amount of the usage amount of the utility is minimized.

43. A storage medium that is a non-transitory computer readable storage medium storing a schedule creating program to be executed by a computer, and
wherein the schedule creating program makes the computer execute computing in accordance with the schedule creating method according to claim 22.

44. (canceled)
